(19) United States
(12) Patent Application Publication
(10) Pub. No.: US 2020/0132481 A1
(43) Pub. Date: Apr. 30, 2020

(54) INFORMATION PROVIDING DEVICE, INFORMATION PROVIDING SYSTEM, INFORMATION PROVIDING METHOD, AND RECORDING MEDIUM

(71) Applicant: TOYOTA JIDOSHA KABUSHIKI KAISHA, Toyota-shi (JP)

(72) Inventors: Hiroshi MAJIMA, Tokyo (JP); Nariaki AMANO, Nagoya-shi (JP); Yukiya YAMANE, Tokyo (JP); Kazuki KATO, Kawaguchi-shi (JP)

(73) Assignee: TOYOTA JIDOSHA KABUSHIKI KAISHA, Toyota-shi (JP)

(21) Appl. No.: 16/561,109

(22) Filed: Sep. 5, 2019

(30) Foreign Application Priority Data
Oct. 30, 2018 (JP) 2018-204543

(51) Int. Cl. G01C 21/34; G01C 21/36

(52) U.S. Cl. CPC G01C 21/3438; G01C 21/3614; G01C 21/3423; G01C 21/3694

(57) ABSTRACT

An information providing device includes: a route search unit configured to search a route from a departure place to a destination place, the route using one or more of a plurality of movement means; and a display control unit configured to cause a display unit of a user terminal to display a route search result by the route search unit, in accordance with a display specification, the route search result including one or a plurality of route candidates, wherein a first display specification includes at least one of information of whether to display a particular route candidate and a display order of the particular route candidate in the plurality of route candidates, the first display specification is determined based on a unique condition that is specified for particular movement means, and the particular route candidate is a route candidate that uses the particular movement means.

### INCORPORATION BY REFERENCE

The disclosure of Japanese Patent Application No. 2018-204543 filed on Oct. 30, 2018 including the specification, drawings and abstract is incorporated herein by reference in its entirety.

### BACKGROUND

### 1. Technical Field

The disclosure relates to an information providing device, an information providing system, an information providing method, and a recording medium.

### 2. Description of Related Art

As the related art, there is known a navigation device that performs a multimodal route search for a route from a departure place to a destination place that uses one or more of a plurality of movement means such as an automobile, walking, a bicycle and public transportations (see Japanese Patent Application Publication No. 2012-167994, for example).

### SUMMARY

In the multimodal route search, a plurality of route candidates from the departure place to the destination place can be obtained. On this occasion, for example, on a screen of a user terminal such as a smartphone, the plurality of route candidates is sometimes provided to the user, in an order in line with a rule common to the plurality of route candidates, as exemplified by an ascending order according to arrival time.

However, the plurality of route candidates sometimes includes two or more route candidates that are different from each other in the movement means to be used or the combination of the movement means, and a criterion by which the user selects one route candidates from the plurality of route candidates can vary depending on movement means to be used in the route candidates or the combination of the movement means. For example, in the case of a taxi, when the use distance is long, the possibility of the selection by the user can greatly decrease because of the fee and the like. In contrast, in the case of a private-use automobile, even when the distance is long, the possibility of the selection by the user can be maintained to some extent, although fuel costs are necessary. Therefore, for example, in a configuration in which the plurality of route candidates is displayed on the user terminal in line with the common rule, there is a possibility that the common rule does not match with the selection criterion of the user when the user selects one route candidate from the plurality of route candidates. Accordingly, there is room for improvement, from a standpoint of convenience for the user.

Hence, the disclosure provides an information providing device and the like that make it possible to enhance the convenience for the user when the user selects one route candidate from the plurality of route candidates by the multimodal route search.

An information providing device according to a first aspect of the disclosure is an information providing device that is capable of communicating with a user terminal or is mounted on the user terminal, the information providing device including: a route search unit configured to search a route from a departure place to a destination place, the route using one or more of a plurality of movement means; and a display control unit configured to cause a display unit of a user terminal to display a route search result by the route search unit, in accordance with a display specification, the route search result including one or a plurality of route candidates, wherein a first display specification includes at least one of information of whether to display a particular route candidate and a display order of the particular route candidate in the plurality of route candidates, the first display specification being a display specification that is relevant to the particular route candidate, the first display specification is determined based on a unique condition that is specified for particular movement means, and the particular route candidate is a route candidate that uses the particular movement means, the particular movement means being included in the plurality of movement means.

With the above aspect, although the criterion by which the user selects one route candidate from the plurality of route candidates can vary depending on movement means to be used in the route candidate, the information providing device can adopt the unique condition for the particular movement means, to the display specification of the particular route candidate using the particular movement means. Accordingly, for example, the unique condition of the particular movement means is set in line with the criterion by which the user selects the particular route candidate including the particular movement means, and thereby, the information providing device makes it possible to enhance the convenience for the user when user selects one route candidate from the plurality of route candidates.

In the above aspect, a second display specification may include the display order, the second display specification being a display specification that is relevant to a route candidate other than the particular route candidate of the plurality of route candidates; and the second display specification may be determined based on a common condition that is specified for the plurality of route candidates.

With the above configuration, the information providing device can cause the user terminal to display the particular route candidate using the particular movement means, with the unique condition, on the premise that the information providing device causes the display unit to display the plurality of movement candidates with the common condition, for example, in ascending order according to required time.

In the above aspect, the first display specification may include the information of whether to display the particular route candidate and the display order of the particular route candidate; the first display specification may be determined based on the common condition and the unique condition; and the unique condition may be applied in preference to the common condition.

With the above configuration, for the particular route candidate using the particular movement means, the information providing device can preferentially apply the unique condition, and furthermore, in a situation where the common condition can be applied, the information providing device can apply the common condition, and can cause the user terminal to display the particular route candidate with the common condition.

In the above aspect, the particular movement means may include at least one of a taxi and a ride sharing; and the display control unit may be configured to cause the display unit to display the particular route candidate, when a use distance of the particular movement means in the particular route candidate is shorter than a first threshold, and cause the display unit not to display the particular route candidate, when the use distance is equal to or longer than the first threshold.

In the case of the route candidate using the taxi or the ride sharing, when the use distance is relatively long, the possibility of the selection by the user can greatly decrease because of the fee. With the above configuration, in consideration of this point, the information providing device can provide the route candidate using the taxi or the ride sharing, to the user.

In the above aspect, the particular movement means may include walking; and the display control unit may be configured to cause the display unit to display the particular route candidate, when a used distance of the walking in the particular route candidate is shorter than a second threshold, and cause the display unit not to display the particular route candidate, when the use distance of the walking is equal to or longer than the second threshold.

In the case of the route candidate using the walking, when the use distance is relatively high, the possibility of the selection by the user can greatly decrease because of physical exhaustion, required time and the like. With the above configuration, in consideration of that point, the information providing device can provide the route search result with the walking.

In the above aspect, the particular movement means may include at least one of a private-use automobile and a private-use bicycle; and the display control unit may be configured to cause the display unit to display a first route candidate in a state where a position of the first route candidate is fixed to be later than route candidates other than the first route candidate, the first route candidate being a route candidate that is included in the plurality of route candidates and that uses only the automobile or the bicycle.

There is a relatively low possibility that the user of the multimodal route search preferentially selects the route search result with the private-use automobile or bicycle. With the above configuration, in consideration of this point, the information providing device can provide the route candidate using only the private-use automobile or bicycle, to the user, for comparison with the other route candidates.

An information providing system according to a second aspect of the disclosure includes a user terminal and an information processing device configured to communicate with the user terminal. The information providing system includes: a route search unit configured to search a route from a departure place to a destination place, the route using one or more of a plurality of movement means; and a display control unit configured to cause a display unit of the user terminal to display a route search result by the route search unit, in accordance with a display specification, the route search result including one or a plurality of route candidates, wherein a first display specification includes at least one of information of whether to display a particular route candidate and a display order of the particular route candidate in the plurality of route candidates, the first display specification being a display specification that is relevant to the particular route candidate, the first display specification is determined based on a unique condition that is specified for particular movement means, and the particular route candidate is a route candidate that uses the particular movement means, the particular movement means being included in the plurality of movement means.

An information providing method according to a third aspect of the disclosure is executed by an information providing device. The information providing method includes: searching a route from a departure place to a destination place, the route using one or more of a plurality of movement means; and causing a display unit of a user terminal to display a route search result, in accordance with a display specification, the route search result including one or a plurality of route candidates, wherein a first display specification includes at least one of information of whether to display a particular route candidate and a display order of the particular route candidate in the plurality of route candidates, the first display specification being a display specification that is relevant to the particular route candidate, the first display specification is determined based on a unique condition that is specified for particular movement means, and the particular route candidate is a route candidate that uses the particular movement means, the particular movement means being included in the plurality of movement means.

A non-transitory recoding medium according to a forth aspect of the disclosure stores a program that causes an information providing device to execute: searching a route from a departure place to a destination place, the route using one or more of a plurality of movement means; and causing a display unit of a user terminal to display a route search result, in accordance with a display specification, the route search result including one or a plurality of route candidates, wherein a first display specification includes at least one of information of whether to display a particular route candidate and a display order of the particular route candidate in the plurality of route candidates, the first display specification being a display specification that is relevant to the particular route candidate, the first display specification is determined based on a unique condition that is specified for particular movement means, and the particular route candidate is a route candidate that uses the particular movement means, the particular movement means being included in the plurality of movement means.

The above-described aspects can provide the information providing device and the like that make it possible to enhance the convenience for the user when the user selects one route candidate from the plurality of route candidates by the multimodal route search.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an exemplary configuration of a multimodal route providing system according to an embodiment;

FIG. 2 is a configuration diagram showing an exemplary hardware configuration of a portable terminal;

FIG. 3 is a functional block diagram showing exemplary functional configurations of a center server and the portable terminal;

FIG. 4 is a diagram for describing an exemplary user handling method for requesting a multimodal route search;

FIG. 5A is a diagram for describing an alternative exemplary user handling method for requesting the multimodal route search;

FIG. 5B is a diagram for describing the alternative exemplary user handling method for requesting the multimodal route search;

FIG. 6A is a diagram for describing a further alternative exemplary user handling method for requesting the multimodal route search;

FIG. 6B is a diagram for describing the further alternative exemplary user handling method for requesting the multimodal route search;

FIG. 6C is a diagram for describing the further alternative exemplary user handling method for requesting the multimodal route search;

FIG. 7 is a diagram showing an exemplary setting screen for setting object movement means in the multimodal route search;

FIG. 8A is a diagram showing an exemplary display screen for a multimodal route search result;

FIG. 8B is a diagram showing an exemplary display screen for the multimodal route search result;

FIG. 9 is a diagram for describing an exemplary decision method for the object movement means that is displayed in association with a route candidate;

FIG. 10A is a diagram for describing an exemplary use method for a taxi based on the multimodal route search result;

FIG. 10B is a diagram for describing the exemplary use method for the taxi based on the multimodal route search result;

FIG. 11A is a diagram for describing an exemplary viewing method for parking place information based on the multimodal route search result;

FIG. 11B is a diagram for describing the exemplary viewing method for the parking place information based on the multimodal route search result;

FIG. 12A is a diagram for describing an exemplary use method for a cycle sharing based on the multimodal route search result;

FIG. 12B is a diagram for describing the exemplary use method for the cycle sharing based on the multimodal route search result;

FIG. 13A is a diagram for describing an exemplary viewing method for fixed-route bus position information based on the multimodal route search result and an exemplary purchase-use method for a fixed-route bus ticket;

FIG. 13B is a diagram for describing the exemplary viewing method for the fixed-route bus position information based on the multimodal route search result and the exemplary purchase-use method for the fixed-route bus ticket;

FIG. 14A is a flowchart schematically showing an exemplary fixed-route bus ticket information display process by the portable terminal (fixed-route bus ticket use assist processing unit);

FIG. 14B is a flowchart schematically showing an exemplary fixed-route bus ticket information display process by the portable terminal (fixed-route bus ticket use assist processing unit);

FIG. 15A is a diagram showing exemplary history data of the multimodal route search result;

FIG. 15B is a diagram showing the exemplary history data of the multimodal route search result;

FIG. 16A is a diagram for describing a generation method for macro data;

FIG. 16B is a diagram for describing the generation method for the macro data;

FIG. 16C is a diagram for describing the generation method for the macro data; and

FIG. 16D is a diagram for describing the generation method for the macro data.

### DETAILED DESCRIPTION OF EMBODIMENTS

Hereinafter, an embodiment for carrying out the disclosure will be described with reference to the drawings.

Overview of System

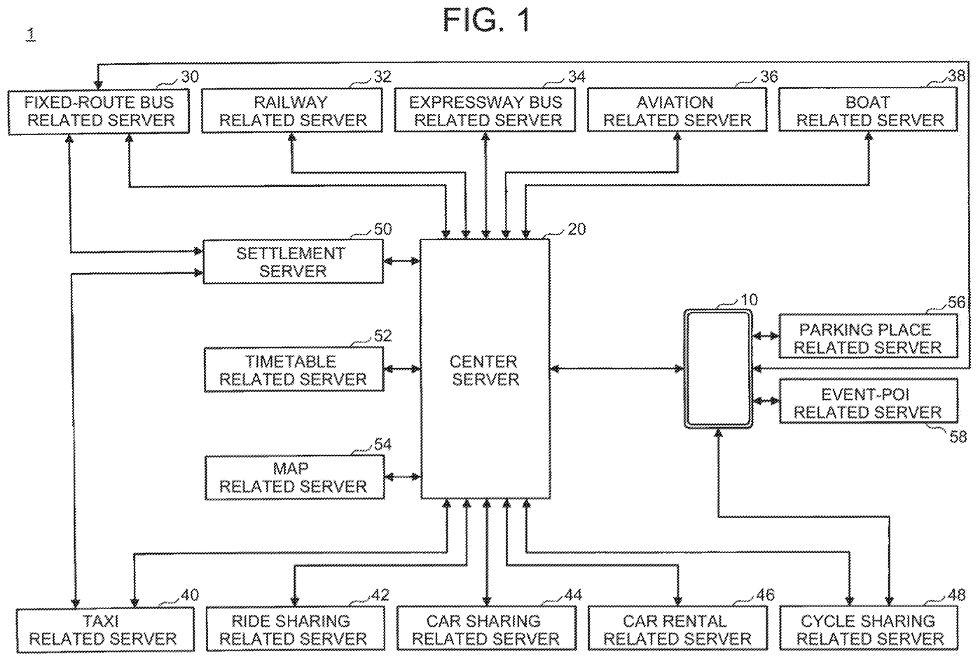

First, an overview of a multimodal route providing system 1 according to the embodiment will be described with reference to FIG. 1.

FIG. 1 is a schematic diagram showing an exemplary configuration of the multimodal route providing system 1 according to the embodiment.

The multimodal route providing system 1 according to the embodiment includes a portable terminal 10 and a center server 20.

In the multimodal route providing system 1 (an example of the information providing system), the portable terminal 10 sends a route search request including a departure place and a destination place, to the center server 20, in response to a handling by the user. The center server 20 performs a multimodal route search for a route from the departure place to the destination place, in response to the route search request. Then, the multimodal route providing system 1 provides a route search result (referred to as a “multimodal route search result”, hereinafter), to a user, through the portable terminal 10 (specifically, through a display device 16 described later). The multimodal route providing system 1 may provide the multimodal route search result to a plurality of users. There is a plurality of portable terminals 10 corresponding to the plurality of users. On this occasion, the users performs user registration, for example, through a later-described route search application of the portable terminal 10 or through a homepage about the multimodal route search that is published by the center server 20, and thereby, can receive provision of services about the multimodal route search. Further, user identification information (for example, a user ID (identifier)) and user authentication information (for example, a password) that is information for access to the center server 20 and that corresponds to the user identification information are issued for each of the users having performed the user registration. The user authentication information may be configured as information that can be changed by the user. Thereby, specifically, the user can use the later-described route search application and can receives provision of services about the multimodal route search, using the user identification information and the user authentication information.

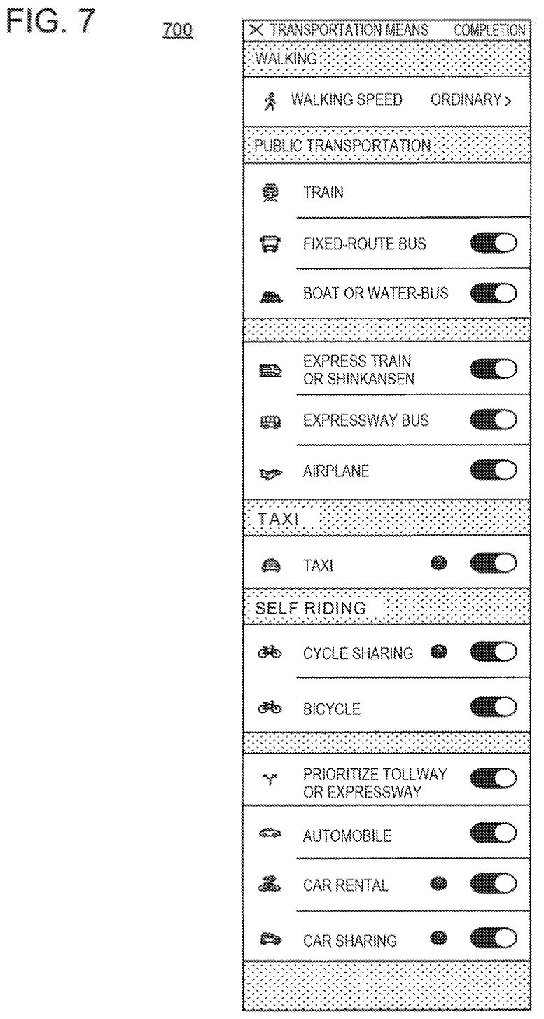

The multimodal route search is the search for a route from the departure place to the destination place. On the route from the departure place to the destination place, a plurality of movement means can be used. The multimodal route search can be realized by a known technique. By the multimodal route search, one or a plurality of route candidates that uses one or more of a plurality of movement means as objects (referred to as “object movement means”, hereinafter) is searched. For example, the object movement means may include a public transportation such as a fixed-route bus, a railway, an expressway bus, an airplane, and a boat. Further, the object movement means may include movement means (referred to as “share-type movement means”, hereinafter) in which a riding machine having a relatively small riding capacity is shared by unspecified persons, as exemplified by a taxi, a ride sharing, a car sharing, a car rental, and a cycle sharing. Further, the object movement means may include movement means possessed by the user or a family member of the user, as exemplified by a private-use bicycle (referred to as merely a “bicycle”, hereinafter) and a private-use automobile (referred to as merely an “automobile”, hereinafter). The “boat” as the object movement means may include arbitrary on-water transport machines such as a water-bus, and the water-bus and the like may be set as single object movement means, separately from the “boat”. As described later, it is allowable to adopt a configuration in which the user can select the object movement means from a plurality of previously specified movement means (candidates of the object movement means) (see FIG. 7). The departure place and the destination place are set in an object area for the multimodal route search (referred to as a “search object area”, hereinafter). The search object area may be arbitrarily set, and for example, may be set to a region across a plurality of countries, the whole of one country, a local region across a plurality of prefectures or states in one country, one prefecture, one state, one district, or the like.

Constituent elements related to the multimodal route providing system 1 according to the embodiment include a fixed-route bus related server 30, a railway related server 32, an expressway bus related server 34, an aviation related server 36, a boat related server 38, a taxi related server 40, a ride sharing related server 42, a car sharing related server 44, a car rental related server 46, a cycle sharing related server 48, a settlement server 50, a timetable related server 52, a map related server 54, a parking place related server 56, and an event-POI (Point of Interest) related server 58.

The portable terminal 10 is a user terminal through which the user receives provision of one or a plurality of route candidates corresponding to the multimodal route search result. Examples of the portable terminal 10 include a portable phone, a smartphone, a tablet terminal, a laptop computer, a portable (mobile) navigation device.

The portable terminal 10 is communicably connected with the center server 20, through a predetermined communication network (referred to as merely a “communication network”, hereinafter) such as a mobile communication network having a base station as a termination, a satellite communication network using a communication satellite, and an internet network, for example. The portable terminal 10 sends a route search request to the center server 20, in response to a handling by the user. Then, the portable terminal 10 causes the display device 16 to display the multimodal route search result delivered from the center server 20, and thereby, provides the multimodal route search result to the user.

The portable terminal 10 is an exemplary user terminal through which the user receives provision of the multimodal route search result. The multimodal route providing system 1 may include another user terminal (for example, a desktop computer or a navigation device fixed in a vehicle), instead of or in addition to the portable terminal 10.

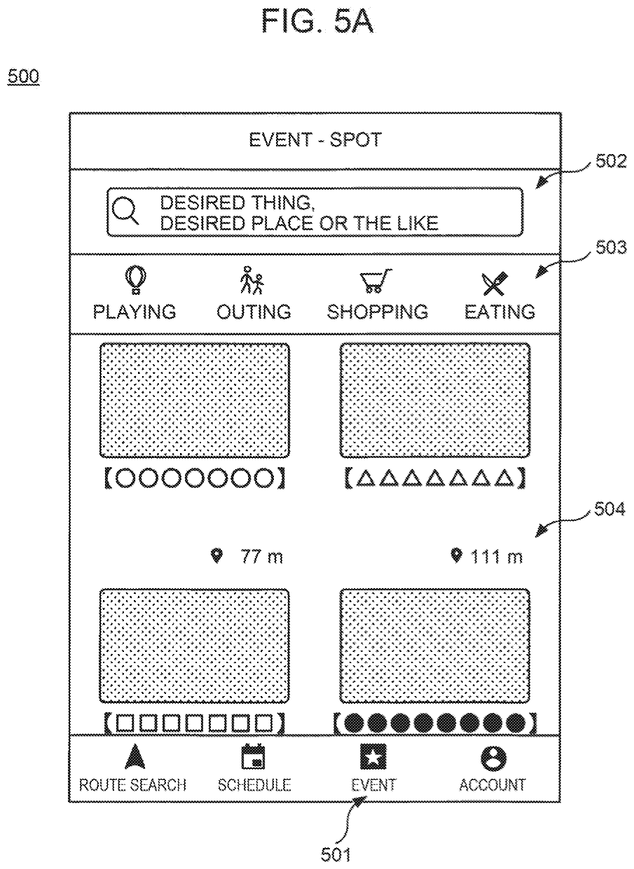

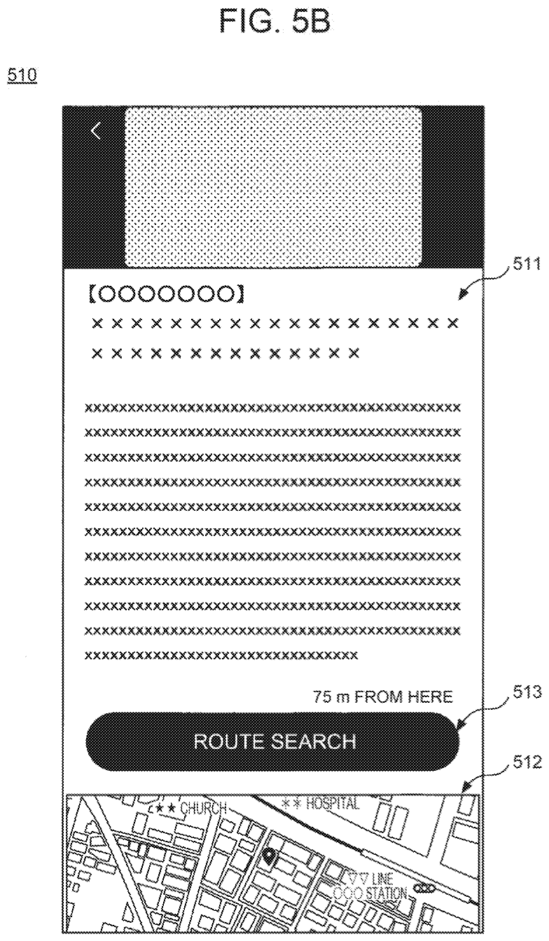

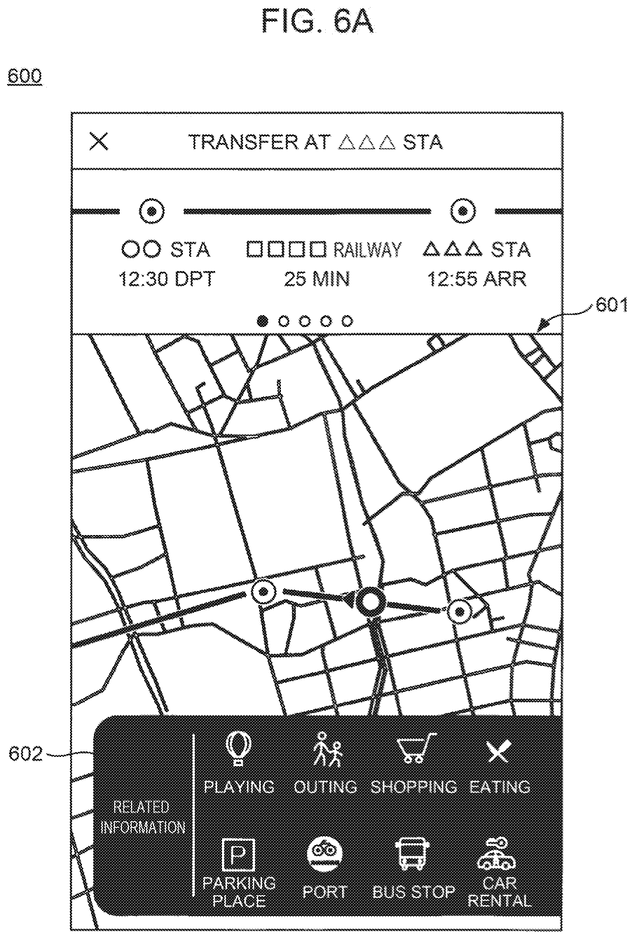

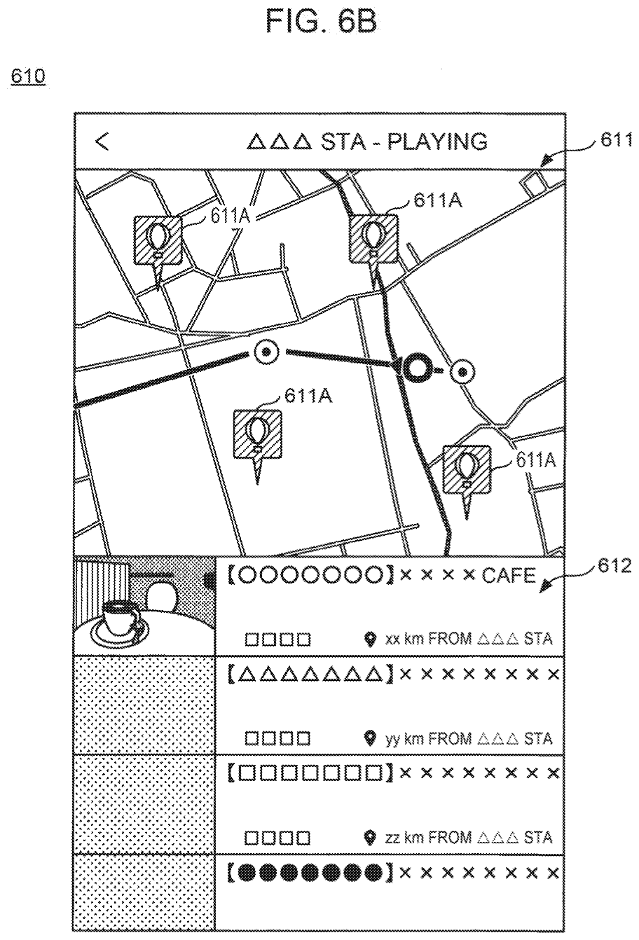

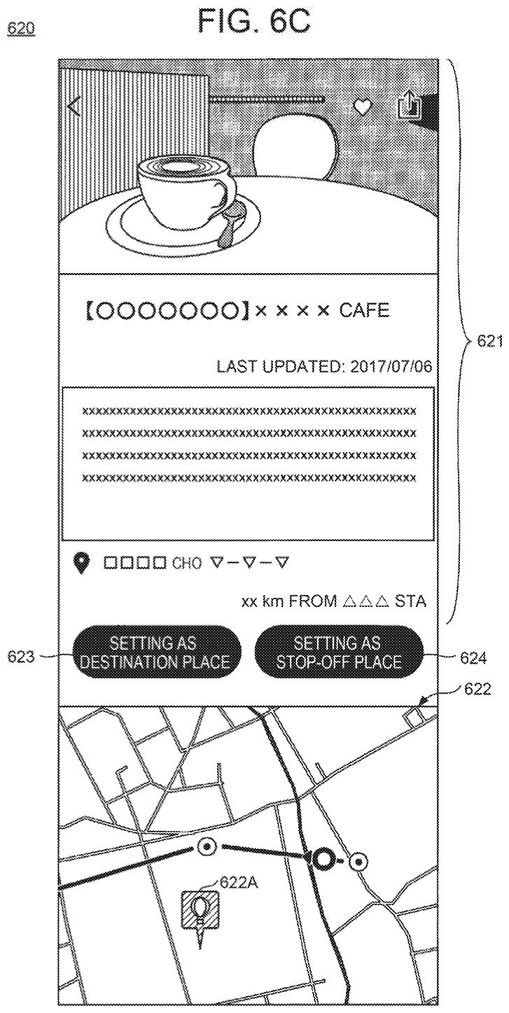

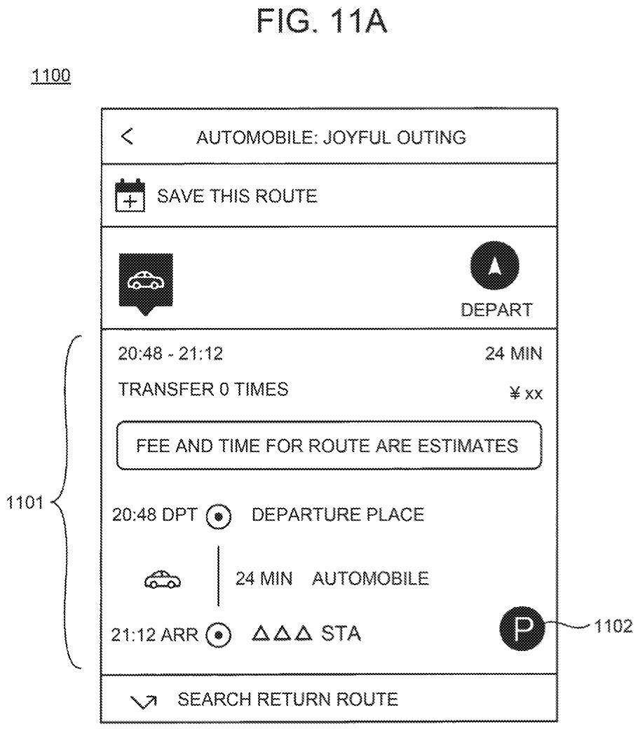

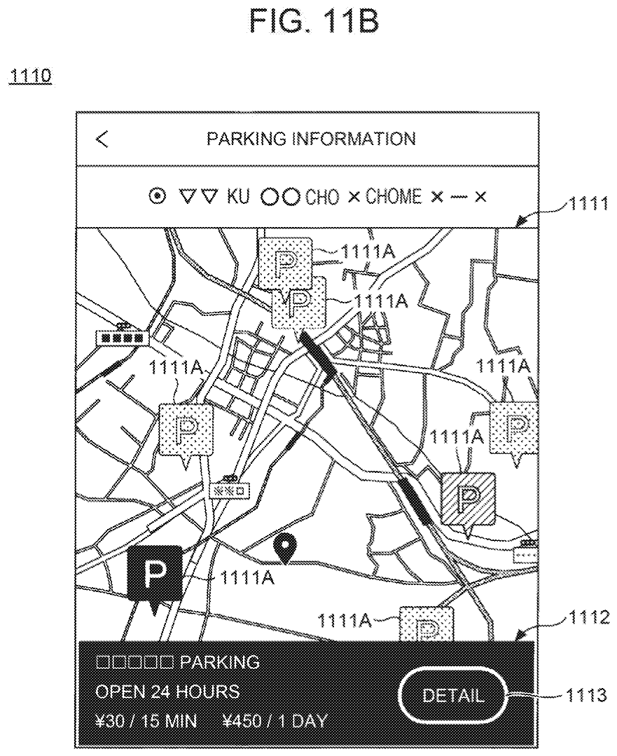

The portable terminal 10 is communicably connected with the fixed-route bus related server 30, the cycle sharing related server 48, the parking place related server 56, the event-POI related server 58, and the like. For example, the fixed-route bus related server 30 is administered by an operation company for the fixed-route bus as the object movement means, a related company of the operation company, or the like, and manages information (for example, an operation situation including a timetable, a delay and the like, and current positions of vehicles) relevant to the operation of the fixed-route bus and the like. For example, the cycle sharing related server 48 is administered by a service providing company for the cycle sharing as the object movement means, a related company of the service providing company, or the like, and manages a variety of information (for example, the number of cycles capable of being provided, the number of currently available cycles, and the like for each of a plurality of cycle ports that provides shared cycles) relevant to services for the cycle sharing. The parking place related server 56 manages facility information (for example, address, the number of parking spots and the like) for each of a plurality of parking places previously registered, and information (for example, the number of available parking spots and the like for each of the parking places) relevant to use situation. The event-POI related server 58 manages information (referred to as “event information”) relevant to an event that is performed in a route search object area and information (referred to as “POI information”) relevant to a POI (for example, a facility, a shop or the like) in a predetermined area, such that the event information and the POI information are in the latest state. Thereby, the portable terminal 10 can acquire a variety of information such as the information relevant to the fixed-route bus and the cycle sharing as the object movement means, the information relevant to the parking place in the case of using the car sharing, the car rental or the automobile as the object movement means, and the information relevant to the event and POI that can motivate the user to move. Details of exchange between the portable terminal 10 and the fixed-route bus related server 30, the cycle sharing related server 48, the parking place related server 56, the event-POI related server 58 or the like will be described later (see FIG. 5A, FIG. 5B, FIG. 6A, FIG. 6B, FIG.6C, FIG. 11A to FIG. 13B, and the like).

The portable terminal 10 may be communicably connected with the railway related server 32, the expressway bus related server 34, the aviation related server 36, the boat related server 38, the taxi related server 40, the ride sharing related server 42, the car sharing related server 44, the car rental related server 46, and the like, and may acquire a variety of information from the servers. For example, the portable terminal 10 may acquire a variety of information from the servers through homepages that are administered by the servers.

The center server 20 (an example of the information providing device) is communicably connected with the portable terminal 10, through the communication network. In response to the route search request from the portable terminal 10, the center server 20 performs the multimodal route search, and sends (delivers) the multimodal route search result to the portable terminal 10.

Further, the center server 20 is communicably connected with the fixed-route bus related server 30, the railway related server 32, the expressway bus related server 34, the aviation related server 36, the boat related server 38, the taxi related server 40, the ride sharing related server 42, the car sharing related server 44, the car rental related server 46, the cycle sharing related server 48, and the like, through the communication network. For example, the railway related server 32 is administered by an operation company for the railway as the object movement means, a related company of the operation company, or the like, and manages information (for example, an operation situation including a timetable, a delay and the like, and a seat availability of each bookable railway train) relevant to the operation of the railway and the like. The expressway bus related server 34 manages information (for example, an operation situation including a timetable, a delay and the like, and a seat availability of each vehicle) related to the operation of the expressway bus as the object movement means and the like. The aviation related server 36 is administered by an operation company for the airplane as the object movement means, a related company of the operation company, or the like, and manages information (for example, an operation situation including a timetable, a delay and the like, and a seat availability of each flight) relevant to the operation of the airplane and the like. The boat related server 38 is administered by an operation company for the boat as the object movement means, a related company of the operation company, or the like, and manages information (for example, an operation situation including a timetable, a delay and the like, and a seat availability of each bookable boat) relevant to the operation of the boat and the like. For example, the taxi related server 40 is administered by a service providing company for the taxi as the object movement means, a related company of the service providing company, or the like, and manages a variety of information (for example, position information about each vehicle, an operation situation including information of whether the vehicle is in an empty running state or in a passenger carrying state, and the like) relevant to services for the taxi. For example, the ride sharing related server 42 is administered by a service providing company for the ride sharing as the object movement means, a related company of the service providing company, or the like, and manages a variety of information (for example, the current position of each vehicle that is operated in the ride sharing, information of whether the vehicle is available, and the like) relevant to services for the ride sharing. For example, the car sharing related server 44 is administered by a service providing company for the car sharing as the object movement means, a related company of the service providing company, or the like, and manages a variety of information (for example, the number of parking spaces, the number of currently available shared cars, the number of returnable shared cars, and the like in each station that provides shared cars) relevant to services for the car sharing. For example, the car rental related server 46 is administered by a service providing company for the car rental as the object movement means, a related company of the service providing company, or the like, and manages a variety of information (for example, vehicle models of vehicles that can be prepared at each service office that rents rented cars, the number of vehicles that can be currently prepared for each vehicle model at each service office, and the like) relevant to services for the car rental. That is, each of the servers 30 to 48 corresponds to the object movement means in the multimodal route search. Thereby, the center server 20 can acquire a variety of information related to the object movement means in the multimodal route search, from each of the servers 30 to 48.

Timetable information about the movement means (for example, the fixed-route bus, the railway, the expressway bus, the airplane, the boat, and the like) for which an operation plan including an operation route and an operation hour is previously specified may be acquired from the timetable related server 52, as described later. The service for each kind of the object movement means can be provided by a plurality of companies. Therefore, the fixed-route bus related server 30, the railway related server 32, the expressway bus related server 34, the aviation related server 36, the boat related server 38, the taxi related server 40, the ride sharing related server 42, the car sharing related server 44, the car rental related server 46, and the cycle sharing related server 48 may be provided for each of the companies that provide the service for the corresponding kind of the object movement means. Further, one company or one company group can perform services for a plurality of kinds of object movement means. Therefore, some of the fixed-route bus related server 30, the railway related server 32, the expressway bus server 34, the aviation related server 36, the boat related server 38, the taxi related server 40, the ride sharing related server 42, the car sharing related server 44, the car rental related server 46, and the cycle sharing related server 48 may be realized by one server corresponding to the one company or the one company group.

Further, the center server 20 is communicably connected with the settlement server 50 through the communication network. For example, the settlement server 50 is administered by a settlement agency or the like, and performs a settlement process relevant to the use of the object movement means by the user, for example, a settlement process for a card company corresponding to a credit card (referred to as a “registered credit card”, hereinafter) that is previously registered in the center server 20 by the user. For example, in response to a request from the center server 20, the settlement server 50 tentatively reserves a credit line for a credit card with a tentative fare, depending on a later-described booking of the taxi by the user. Then, the center server 20 accepts a fare fix notice from the taxi related server 40, and in response to a request from the center server 20, the settlement server 50 reserves the credit line for the credit card with the fixed fare again, and records sales. Further, for example, in response to a request from the center server 20, the settlement server 50 reserves the credit line for the credit card, depending on a purchase request for a later-described fixed-route bus ticket from the user, and records sales. Thereby, the center server 20 can cause the settlement server 50 to unitarily execute various settlement processes relevant to the use of the object movement means by the user.

Further, the center server 20 is communicably connected with the timetable related server 52 and the map related server 54. The timetable related server 52 manages information relevant to the timetable of the object movement means for which the operation plan including the operation route and the operation hour is previously specified. The map related server 54 manages map information including road information in the search object area. Thereby, the center server 20 can acquire the timetable-relevant information and map information necessary for the multimodal route search, from the timetable related server 52 and the map related server 54, and can update the time-table-relevant information, the map information and the like.

Configuration of Multimodal Route Providing System

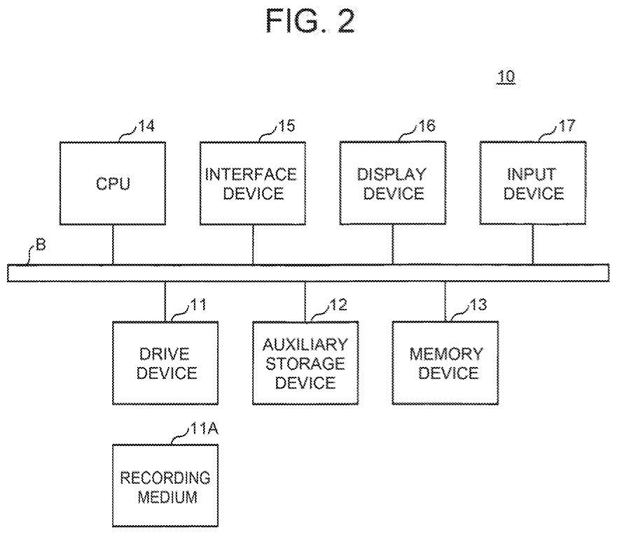

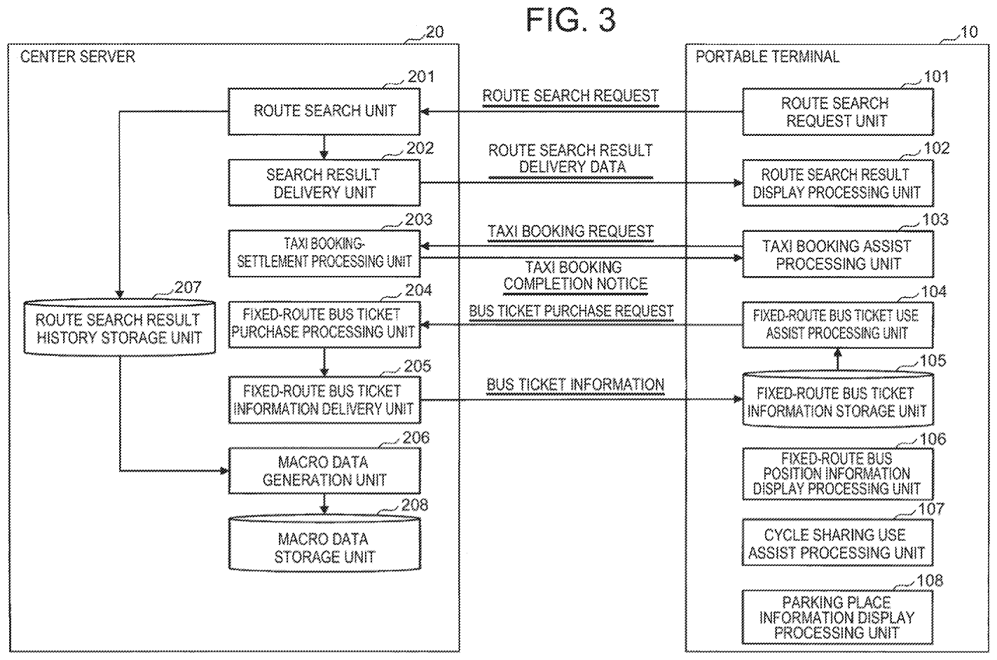

Next, the configuration of the multimodal route providing system 1 will be described in detail with reference to FIG. 2 and FIG. 3, in addition to FIG. 1.

FIG. 2 is a diagram showing an exemplary hardware configuration of the portable terminal 10. FIG. 3 is a functional block diagram showing an exemplary functional configuration of the multimodal route providing system 1.

The hardware configuration of the center server 20 is nearly the same as that of the portable terminal 10. Therefore, the following description will be made with reference to FIG. 2, and illustration of the hardware configuration of the center server 20 will be omitted. Hereinafter, in the description of the center server 20, reference characters “11”, “11A”, “12”, “13”, “14”, “15”, “16” and “17” in FIG. 2 are replaced with reference characters “21”, “21A”, “22”, “23”, “24”, “25”, “26” and “27”.

Configuration of Portable Terminal

As shown FIG. 2, the portable terminal 10 includes a drive device 11, an auxiliary storage device 12, a memory device 13, a central processing unit (CPU) 14, an interface device 15, the display device 16, and an input device 17, which are connected with each other through a bus B.

Programs for realizing various functions of the portable terminal 10 are provided, for example, by a recording medium 11A. For example, the recording medium 11A is a mobile recording medium such as a compact disc read only memory (CD-ROM), a digital versatile disc read only memory (DVD-ROM), a universal serial bus (USB) memory and a SD memory card. Each of the recording medium 11A and the auxiliary storage device 12 is a computer-readable recording medium. The recording medium 11A in which the programs are recorded is set in the drive device 11. Then, the programs are installed in the auxiliary storage device 12 from the recording medium 11A through the drive device 11. The programs may be downloaded from another computer (for example, the center server 20) through the communication network, and may be installed in the auxiliary storage device 12.

The auxiliary storage device 12 contains the installed programs, and contains necessary files, necessary data and the like. For example, the auxiliary storage device 12 is a hard disk drive (HDD), a flash memory or the like.

When an instruction of start of a program is given, the memory device 13 reads the program from the auxiliary storage device 12, and contains the program.

The CPU 14 executes the programs contained in the memory device 13, and realizes various functions of the portable terminal 10 in accordance with the programs.

For example, the interface device 15 is used as an interface for the connection with the communication network.

For example, the display device 16 (an example of the display unit) displays a graphical user interface (GUI) of an application screen for the later-described route search application, or the like, in accordance with the program that is executed by the CPU 14. For example, the display device 16 is a liquid crystal display or an organic electro luminescence (organic EL) display.

The input device 17 includes, for example, a keyboard, a mouse, a touch panel, a button and the like, and is used when the user inputs various instructions relevant to the portable terminal 10.

As shown in FIG. 3, as function units that are realized when the CPU 14 executes one or more programs installed in the auxiliary storage device 12, for example, an application (referred to as a “route search application”, hereinafter) for receiving the provision of the multimodal route search result, the portable terminal 10 includes a route search request unit 101, a route search result display processing unit 102, a taxi booking assist processing unit 103, a fixed-route bus ticket use assist processing unit 104, a fixed-route bus position information display processing unit 106, a cycle sharing use assist processing unit 107, and a parking place information display processing unit 108. Further, the portable terminal 10 uses a fixed-route bus ticket information storage unit 105 and the like. For example, the fixed-route bus ticket information storage unit 105 can be realized using the auxiliary storage device 12 and the like.

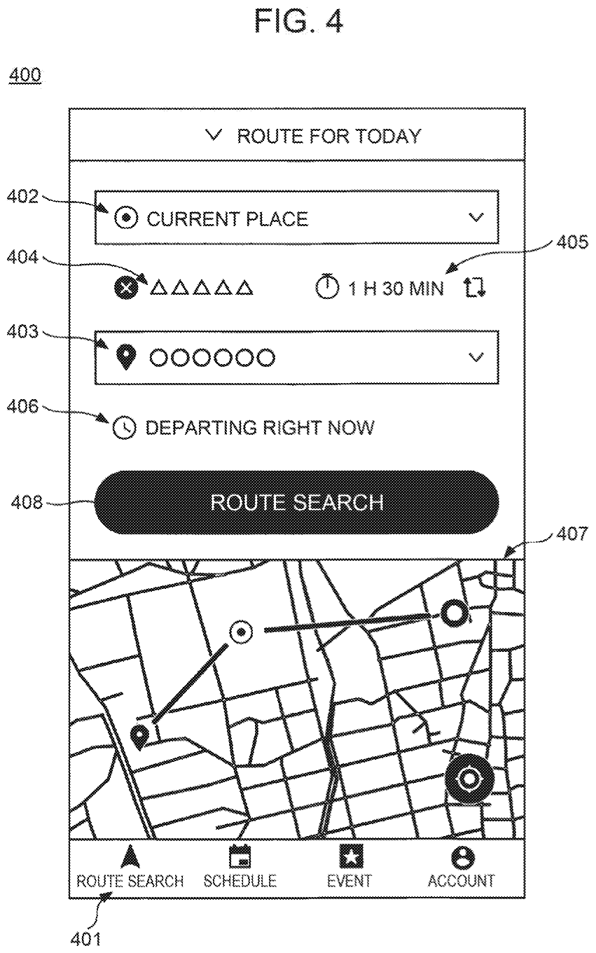

The route search request unit 101 displays an application screen relevant to the route search in the route search application, and sends a route search request including the user identification information, the user authentication information, information relevant to the departure place and the destination place, information relevant to a departure hour, and the like, to the center server 20, in response to a handling on the application screen by the user. The route search request may include information relevant to a stop-off place, as described later (see FIG. 4, FIG. 6A, FIG. 6B and FIG. 6C). An application screen, a handling method and the like when the user requests the multimodal route search, that is, when the user sends the route search request from the portable terminal 10 to the center server 20 will be described later (see FIG. 4 to FIG. 7).

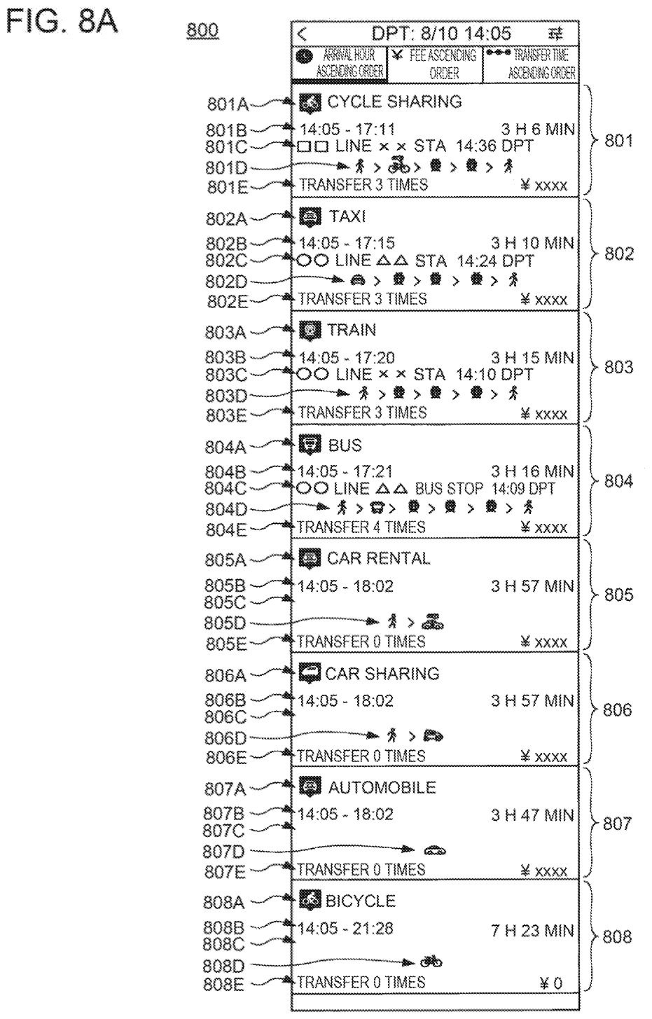

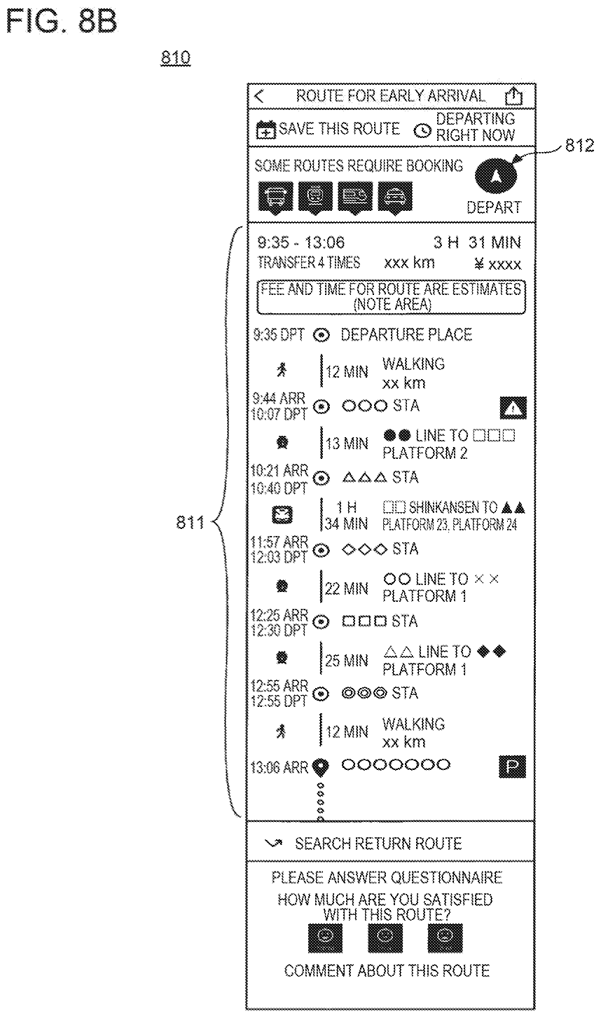

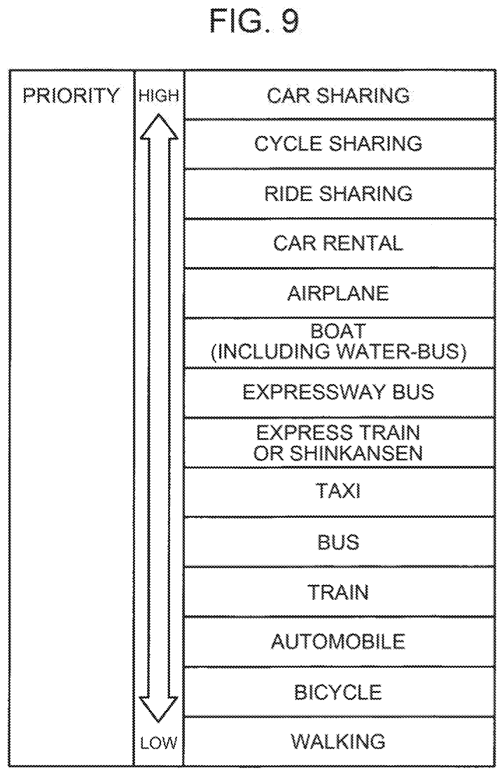

The route search result display processing unit 102 causes the display device 16 to display the multimodal route search result, based on delivery data (referred to as “route search result delivery data”, hereinafter) of the multimodal route search result that is returned (delivered) from the center server 20. Specific contents of the multimodal route search result that is displayed on the display device 16 will be described later (see FIG. 8A, FIG. 8B and FIG. 9).

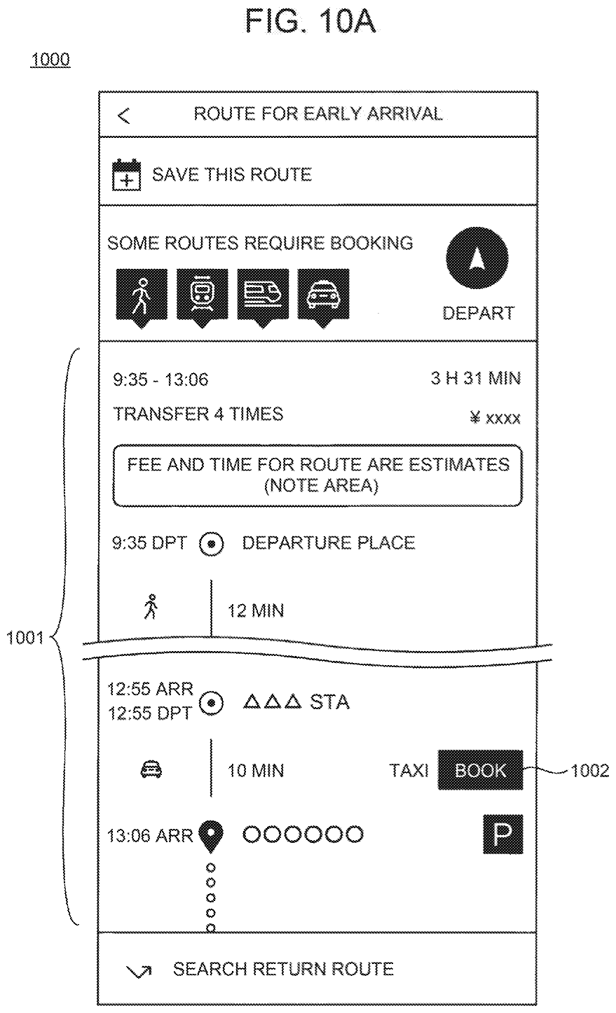

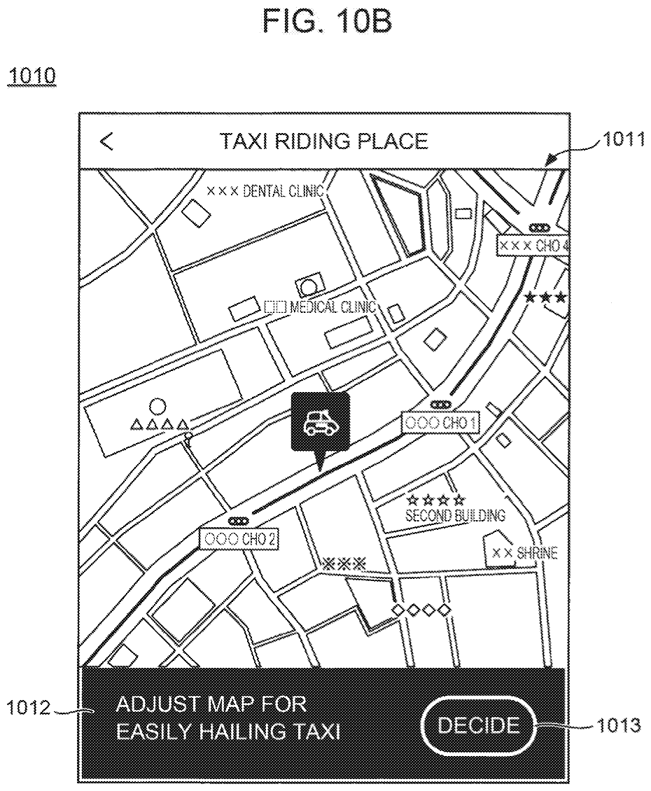

The taxi booking assist processing unit 103 executes a process of assisting a dispatch booking by the user for the taxi as the object movement means, in response to a predetermined handling on a predetermined application screen for the route search application. Specifically, the taxi booking assist processing unit 103 sends a taxi booking request including information relevant to a desired dispatch place and information relevant to a desired dispatch hour, to the center server 20, in response to a predetermined handling by the user on a predetermined application screen for the route search application. Further, the taxi booking assist processing unit 103 may give a notice of completion of the dispatch booking for the taxi, and may display a content of the dispatch booking on the application screen, based on a taxi booking completion notice that is received from the center server 20. An application screen, a handling method and the like when the user performs the dispatch booking for the taxi will be described later (see FIG. 10A and FIG. 10B).

Instead of or in addition to the taxi, the portable terminal 10, similarly, may perform a dispatch booking for the ride sharing, in response to a handling by the user.

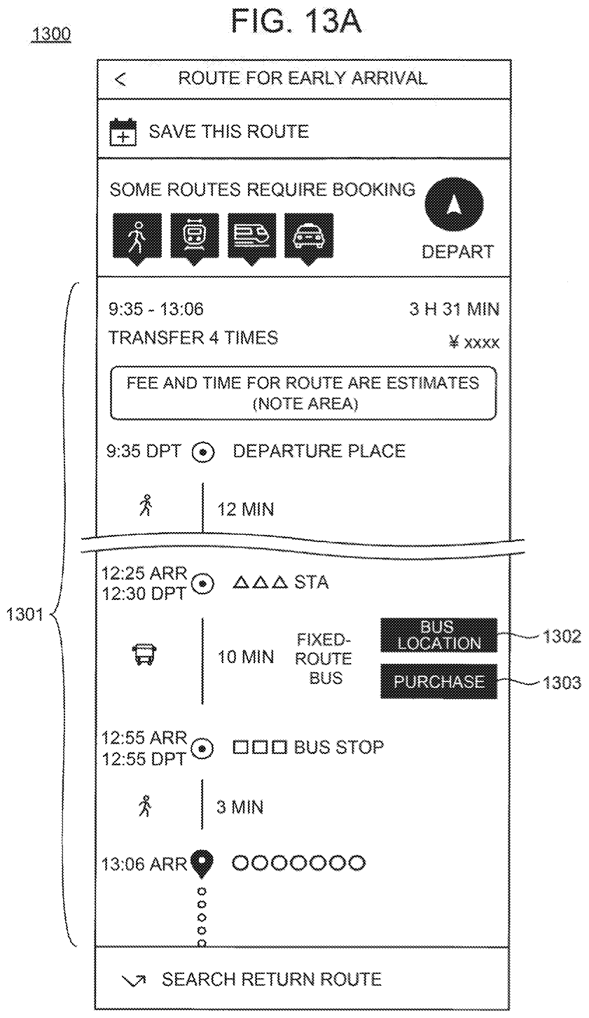

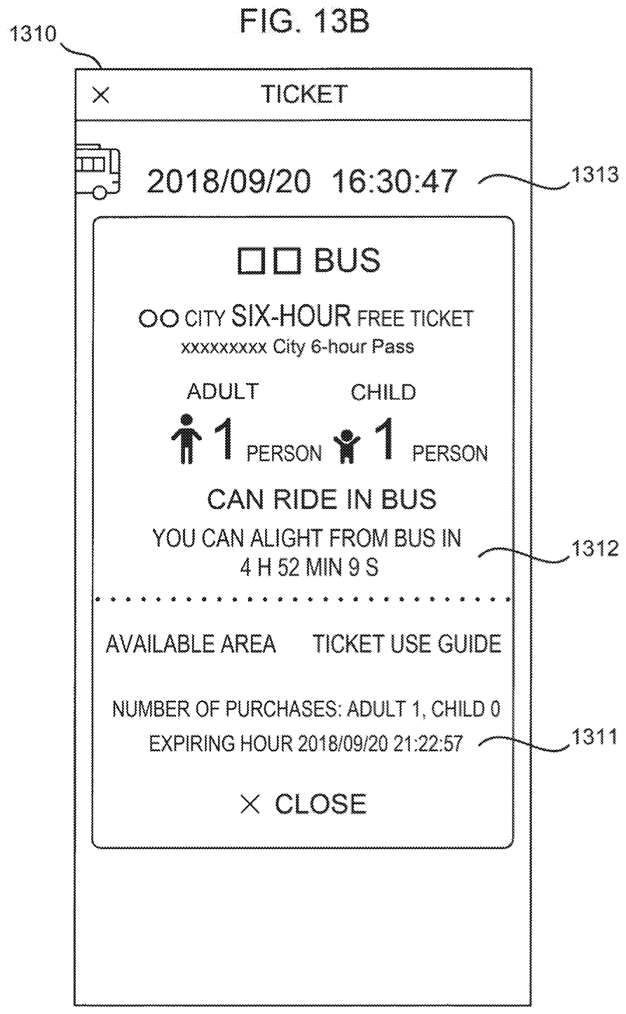

The fixed-route bus ticket use assist processing unit 104 assists the purchase and use of a predetermined ticket for the fixed-route bus as the object movement means, in response to a predetermined handling on a predetermined application screen for the route search application. The predetermined ticket is a ticket (referred to as a “time-limited ticket”, hereinafter) allowing the user to ride in or alight from the fixed-route bus in a predetermined period, as exemplified by a “one-day free ticket”. Further, the time-limited ticket includes a time-limited ticket (referred to as a “specific time-limited ticket”, hereinafter) that can expire at a timing of one day when the fixed-route bus is operating, as exemplified by a “six-hour free ticket”. The time-limited ticket may be further limited to a valid geographic range, exemplified by “only within oo City” and “only on xx Route”. The predetermined ticket may be a ticket (referred to as a “section ticket”, hereinafter) that is limited to a section such as “oo Bus Stop—xx Bus Stop”. Specifically, the fixed-route bus ticket use assist processing unit 104 sends a purchase request (referred to as a “bus ticket purchase request”, hereinafter) for a predetermined ticket for the fixed-route bus, to the center server 20, in response to a predetermined handling by the user on a predetermined application screen for the route search application. Further, the fixed-route bus ticket use assist processing unit 104 causes the display device 16 to display bus ticket information that is received (delivered) from the center server 20 and that is stored in the fixed-route bus ticket information storage unit 105. The bus ticket information corresponds to a predetermined ticket for the fixed-route bus after purchase completion, and the user can use the fixed-route bus by causing a crew member of the fixed-route bus to visually recognize the bus ticket information displayed on the display device 16. An application screen and a handling method when the user purchases a predetermined ticket for the fixed-route bus, a specific example of the fixed-route bus ticket information, and the like will be described later (see FIG. 13A and FIG. 13B).

The fixed-route bus ticket use assist processing unit 104 may send the bus ticket purchase request directly to the fixed-route bus related server 30, without the center server 20. In this case, the portable terminal 10 may acquire the bus ticket information directly from the fixed-route bus related server 30. Instead of or in addition to the fixed-route bus, the portable terminal 10 may assist the purchase and use for other object movement means, particularly, the purchase and use of a ticket for a public transportation for which an operation plan including an operation route and an operation hour is previously specified (for example, a railway ticket, an expressway bus ticket, an airplane ticket, or a boat ticket), similarly to the case of the fixed-route bus.

As described above, the fixed-route bus ticket information storage unit 105 stores (contains) the fixed-route bus ticket information delivered from the center server 20.

The fixed-route bus position information display processing unit 106 causes the display device 16 to display position information about the fixed-route bus as the object movement means, specifically, position information about each vehicle of the fixed-route bus. Specifically, the fixed-route bus position information display processing unit 106 may acquire information (referred to as “current position information”, hereinafter) relevant to the current real-time position of each bus of the fixed-route bus, from the fixed-route bus related server 30, and may cause the display device 16 to display the current position information, in response to a predetermined handling by the user on a predetermined application screen for the route search application. Together with the current position information about each bus of the fixed-route bus, the fixed-route bus position information display processing unit 106 may acquire information (referred to as “scheduled position information”, hereinafter) relevant to a scheduled position in the operation plan, that is, a scheduled position of the fixed-route bus in the case of assuming an operation according to the timetable, from the fixed-route bus related server 30, and may cause the display device 16 to display the scheduled position information. On this occasion, for example, the fixed-route bus position information display processing unit 106 may acquire the current position information and scheduled position information about each bus of the fixed-route bus, through a predetermined web application programming interface (Web API) that is published by the fixed-route bus related server 30. Thereby, while checking the current position of the fixed-route bus, the difference (that is, delay situation) between the current position and the scheduled position, and the like, the user can determine, for example, whether to select a route candidate using the fixed-route bus, from a plurality of route candidates in the multimodal route search result. An application screen, a handling method and the like when the user causes the display device 16 to display the position information about the fixed-route bus will be described later (see FIG. 13A and FIG. 13B).

The fixed-route bus position information display processing unit 106 may acquire the position information about each bus of the fixed-route bus, through the center server 20. Instead of or in addition to the position information about the fixed-route bus, the portable terminal 10 may cause the display device 16 to display position information about other object movement means, particularly, position information about a public transportation for which an operation plan including an operation route and an operation hour is previously specified (for example, position information about each train of the railway or position information about each bus of the expressway bus).

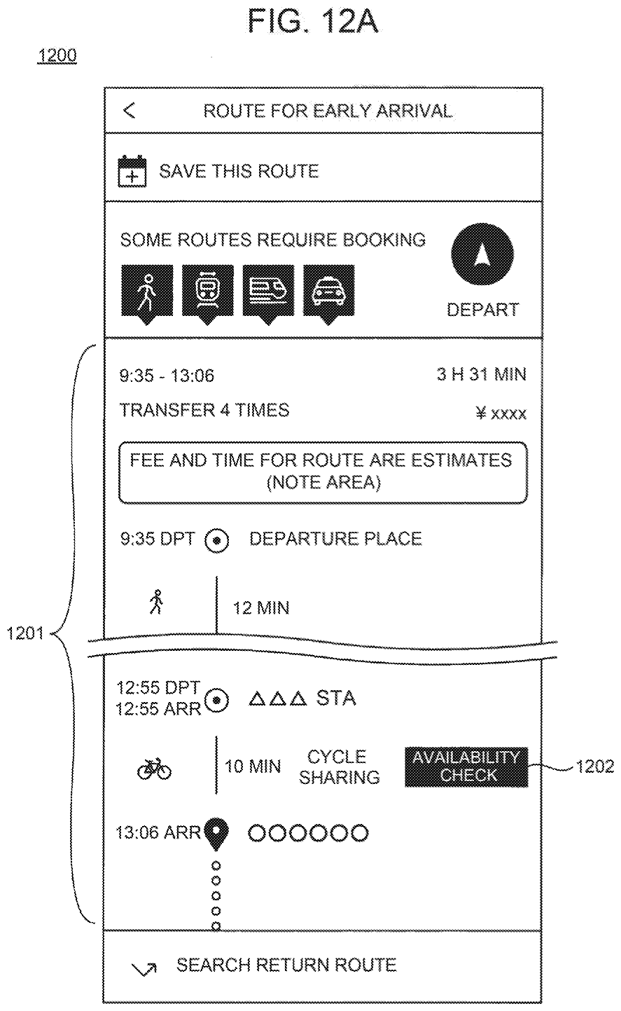

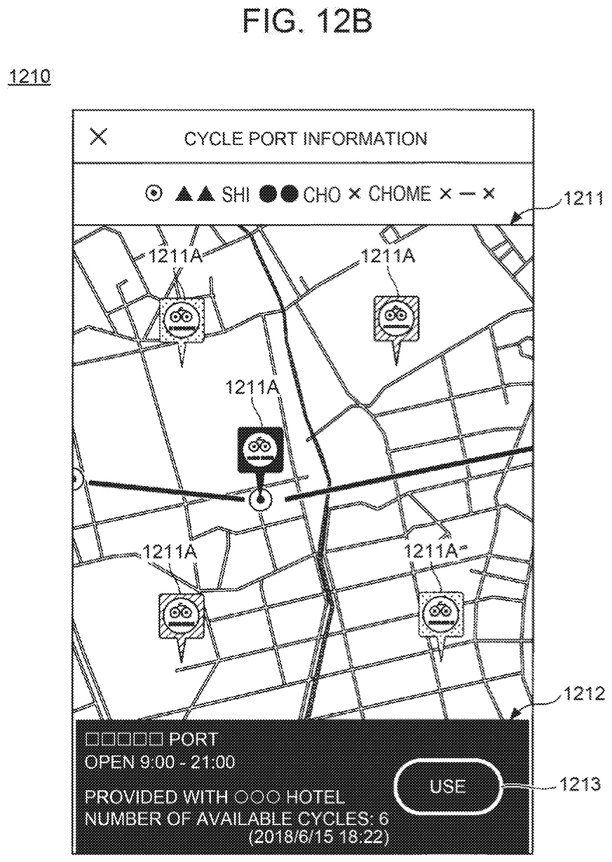

The cycle sharing use assist processing unit 107 assists the user to use the cycle sharing as the object movement means. For example, the cycle sharing use assist processing unit 107 starts an application for using the cycle sharing (for example, an application that is delivered by a cycle sharing service providing company), and causes the display content of the display device 16 to transition to an application screen for the application, in response to a predetermined handling by the user on a predetermined application screen for the route search application. The cycle sharing use assist processing unit 107 may start a browser, and may cause the browser to access a homepage for using the cycle sharing. Thereby, for example, when the user selects a route candidate using the cycle sharing, from a plurality of route candidates in the multimodal route search result, the user can perform a check of the number of available cycles in the corresponding cycle port of the cycle sharing, a booking for actual use, and the like. An application screen, a handling method and the like when the user uses the cycle sharing will be described later (see FIG. 12A and FIG. 12B).

Instead of or in addition to the cycle sharing, the portable terminal 10 may assist use of the car sharing, by the same method as the above method.

The parking place information display processing unit 108 causes the display device 16 to display information (referred to as “parking place information”, hereinafter) relevant to a plurality of parking places that is managed by the parking place related server 56. The parking place information includes facility information about each parking place (for example, the name, address, parking fee, the number of parking spots, and the like of each parking place), information relevant to the number of available parking spots, and the like. For example, the parking place information display processing unit 108 acquires the parking place information from the parking place related server 56, and causes the display device 16 to display the parking place information, in response to a predetermined handling by the user on a predetermined application screen for the route search application. On this occasion, for example, the parking place information display processing unit 108 may acquire the parking place information, through a predetermined Web API that is published by the parking place related server 56. Thereby, for example, when the user selects a route candidate using a private-use automobile, a rented car or the like, which requires a parking place, from a plurality of route candidates in the multimodal route search result, the user can check the availability of the parking place, and the like. An application screen, a handling method and the like when the user views the parking place information will be described later (see FIG. 11A and FIG. 11B).

The parking place information display processing unit 108 may acquire the parking place information through the center server 20. In this case, the parking place related server 56 is communicably connected with the center server 20.

Configuration of Center Server

As shown in FIG. 2, the center server 20 includes a drive device 21, an auxiliary storage device 22, a memory device 23, a CPU 24, an interface device 25, a display device 26, and the input device 27, which are connected with each other through a bus B. In the following, as for the hardware configuration of the center server 20, differences from the drive device 11, the auxiliary storage device 12, the memory device 13, the CPU 14, the interface device 15, the display device 16, the input device 17, and the like of the portable terminal 10 will be mainly described.

Programs for realizing various functions of the center server 20 are provided, for example, by a recording medium 21A. The recording medium 21A in which the programs are recorded is set in the drive device 21. Then, the programs are installed in the auxiliary storage device 22 from the recording medium 21A through the drive device 21. The programs may be downloaded from another computer through the communication network, and may be installed in the auxiliary storage device 22.

The auxiliary storage device 22 contains the installed programs, and contains necessary files, necessary data and the like.

When an instruction of start of a program is given, the memory device 23 reads the program from the auxiliary storage device 22, and contains the program.

The CPU 24 executes various programs contained in the memory device 23, and realizes various functions of the center server 20 in accordance with the programs.

For example, the interface device 25 is used as an interface for the connection with the communication network.

For example, the display device 26 displays a GUI in accordance with the program that is executed by the CPU 24.

The input device 27 is used when an operator, an administrator or the like of the center server 20 inputs various handling instructions relevant to the center server 20.

As shown in FIG. 3, as function units that are realized when the CPU 24 executes one or more programs installed in the auxiliary storage device 22, the center server 20 includes a route search unit 201, a search result delivery unit 202, a taxi booking-settlement processing unit 203, a fixed-route bus ticket purchase processing unit 204, a fixed-route bus ticket information delivery unit 205, and a macro data generation unit 206. Further, the center server 20 uses a route search result history storage unit 207, a macro data storage unit 208, and the like. For example, the route search result history storage unit 207 and the macro data storage unit 208 can be realized, using an external storage device or the like that is communicably connected with the auxiliary storage device 22 or the center server 20.

In response to the route search request that is received from the portable terminal 10, the route search unit 201 performs the multimodal route search for a route between the departure place and the destination place that are designated in the route search request, such that one or more of a plurality of object movement means are used. Then, the route search unit 201 outputs one or a plurality of route candidates each of which uses one or more of the plurality of object movement means. The plurality of route candidates to be output by the route search unit 201 can include two or more route candidates different from each other in one kind of object movement means to be used or in combination of two or more kinds of object movement means. Details of the specification and the like of the multimodal route search by the route search unit 201 will be described later.

The function of the route search unit 201 may be transferred to the portable terminal 10. In this case, for example, the portable terminal 10 may acquire resource information necessary for the multimodal route search, from the center server 20. Further, the portable terminal 10 may be communicably connected with the fixed-route bus related server 30, the railway related server 32, the expressway bus related server 34, the aviation related server 36, the boat related server 38, the taxi related server 40, the ride sharing related server 42, the car sharing related server 44, the car rental related server 46, the cycle sharing related server 48, the timetable related server 52, the map related server 54, and the like, and may acquire the resource information necessary for the multimodal route search, from the servers.

Based on the multimodal route search result output by the route search unit 201 and including one or a plurality of route candidates, the search result delivery unit 202 (an example of the display control unit) generates delivery data (referred to as “route search result delivery data”, hereinafter) for causing the display device 16 of the portable terminal 10 to display the multimodal route search result, and delivers the route search result delivery data to the portable terminal 10. In other words, the search result delivery unit 202 sends the delivery data specifying a display specification for causing the display device 16 of the portable terminal 10 to display the multimodal route search result, to the portable terminal 10, and thereby, causes the display device 16 of the portable terminal 10 to display the multimodal route search result of the route search unit 201.

The display specification for causing the display device 16 of the portable terminal 10 to display the multimodal route search result may be controlled by the portable terminal 10, for example, by the route search result display processing unit 102 (an example of the display control unit). In this case, the route search result delivery data to be delivered from the search result delivery unit 202 to the portable terminal 10 does not include the information relevant to the display specification. In the case where the function of the route search unit 201 is transferred to the portable terminal 10 as described above, the display specification for causing the display device 16 of the portable terminal 10 to display the multimodal route search result is naturally controlled by the portable terminal 10, specifically, by the CPU 14 (an example of the information providing device).

The taxi booking-settlement processing unit 203 performs a booking of the taxi and a settlement process relevant to the use of the taxi that corresponds to the booking of the taxi, in response to the taxi booking request that is received from the portable terminal 10. Specifically, the taxi booking-settlement processing unit 203 requests the booking of the taxi to the taxi related server 40, based on contents (for example, the desired dispatch place, the desired dispatch hour and the like) relevant to a desired dispatch designated in the taxi booking request. After the use corresponding to the booking of the taxi, the taxi booking-settlement processing unit 203 requests the settlement process relevant to the use of the taxi, to the settlement server 50, based on the fixed use fee recorded by the taxi related server 40.

The fixed-route bus ticket purchase processing unit 204 performs a purchase process for a predetermined fixed-route bus ticket, through the settlement server 50, based on the previously registered credit card information about the user, in response to the fixed-route bus ticket purchase request that is received from the portable terminal 10.

The fixed-route bus ticket purchase processing unit 204 may perform the purchase process for the predetermined fixed-route bus ticket, by transmitting the fixed-route bus ticket purchase request by the user to the fixed-route bus related server 30. In this case, the settlement process relevant to the purchase of the predetermined fixed-route bus ticket is performed through the fixed-route bus related server 30 and the like.

After the fixed-route bus ticket purchase processing unit 204 completes the purchase process for the fixed-route bus ticket, the fixed-route bus ticket information delivery unit 205 issues the fixed-route bus ticket information corresponding to the ticket, and delivers (sends) the fixed-route bus ticket information to the portable terminal 10.

The fixed-route bus ticket information delivery unit 205 may acquire the fixed-route bus ticket information that is issued by the fixed-route bus related server 30 as described above, and may deliver the acquired fixed-route bus ticket information to the portable terminal 10.

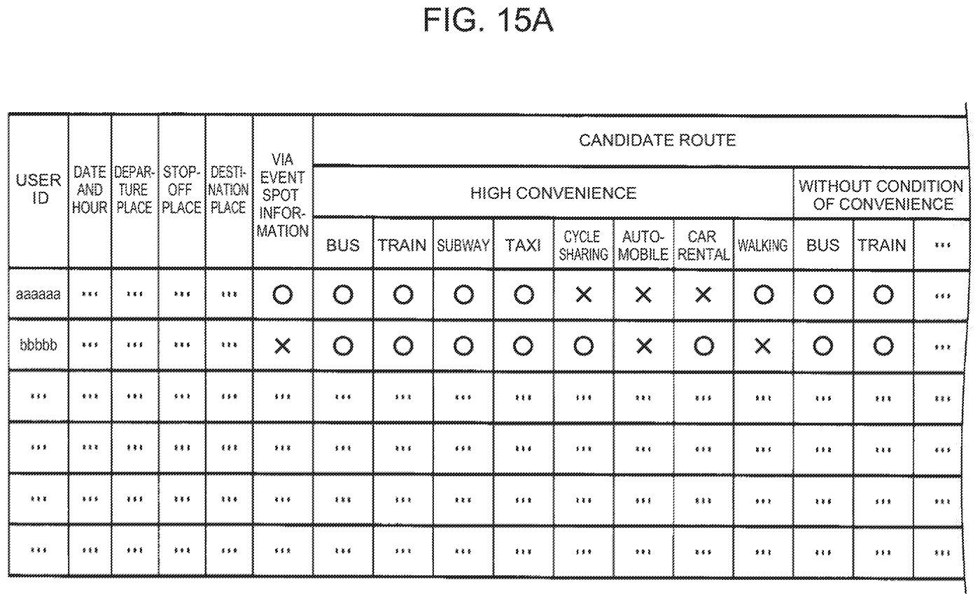

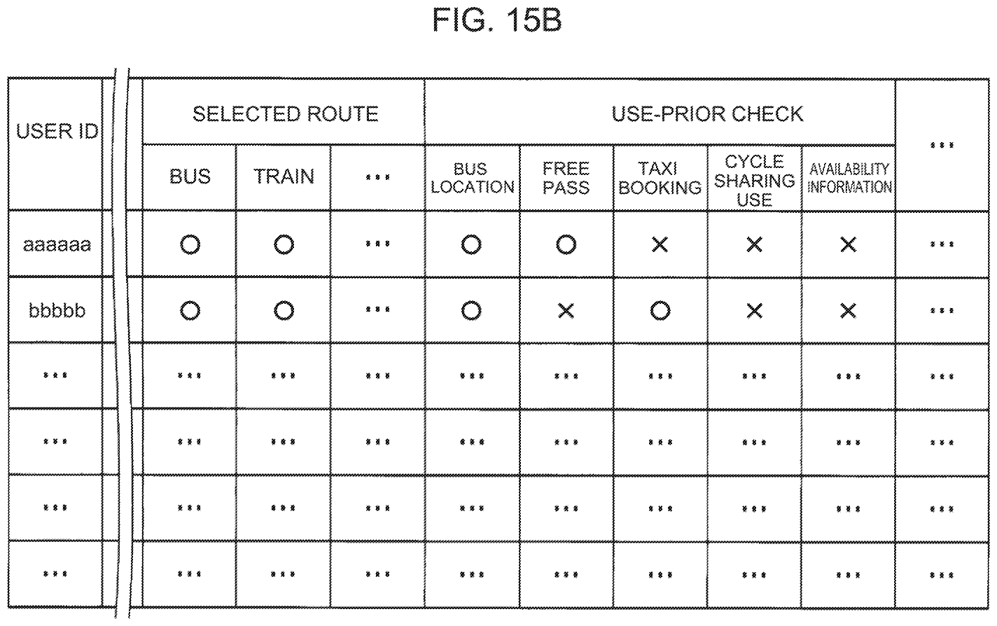

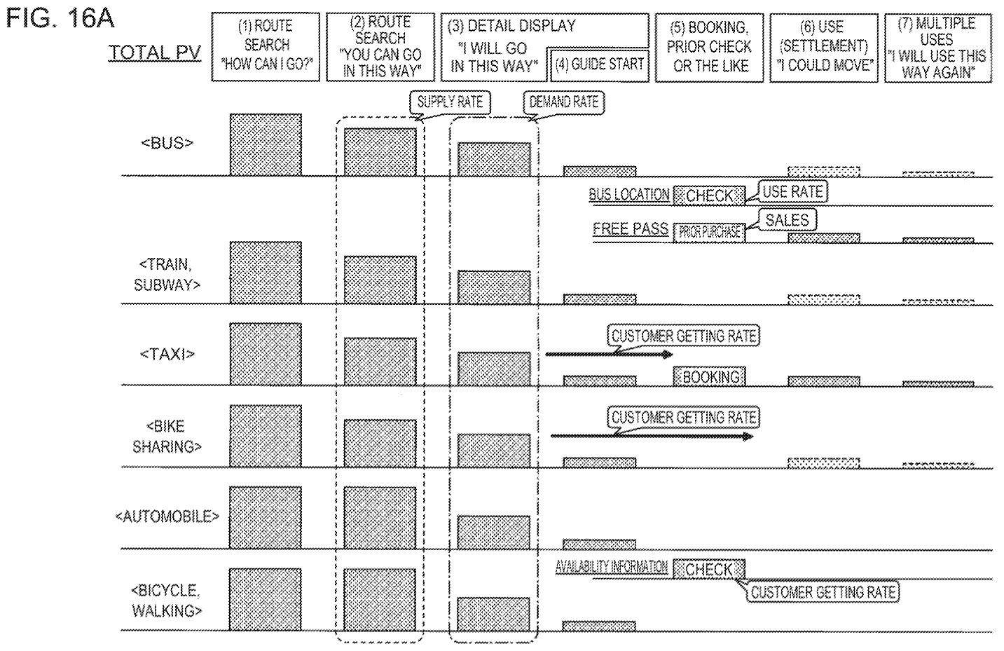

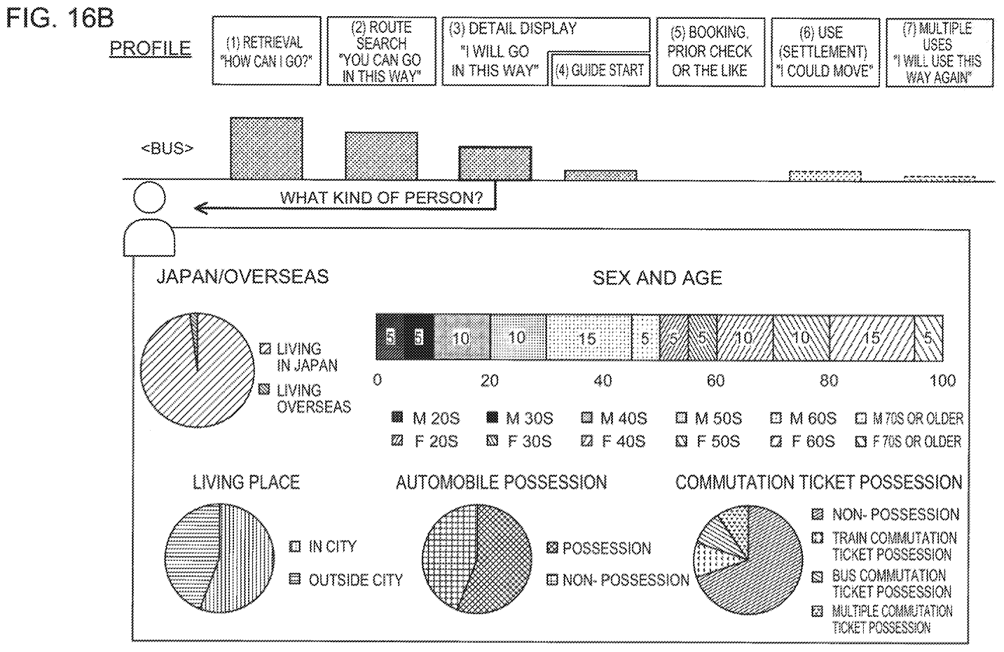

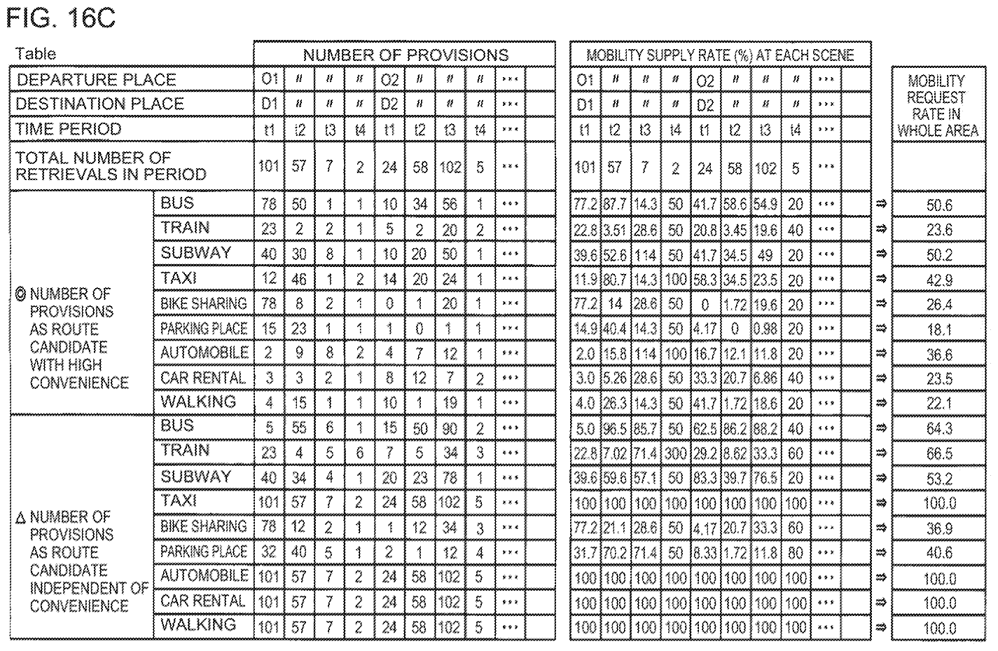

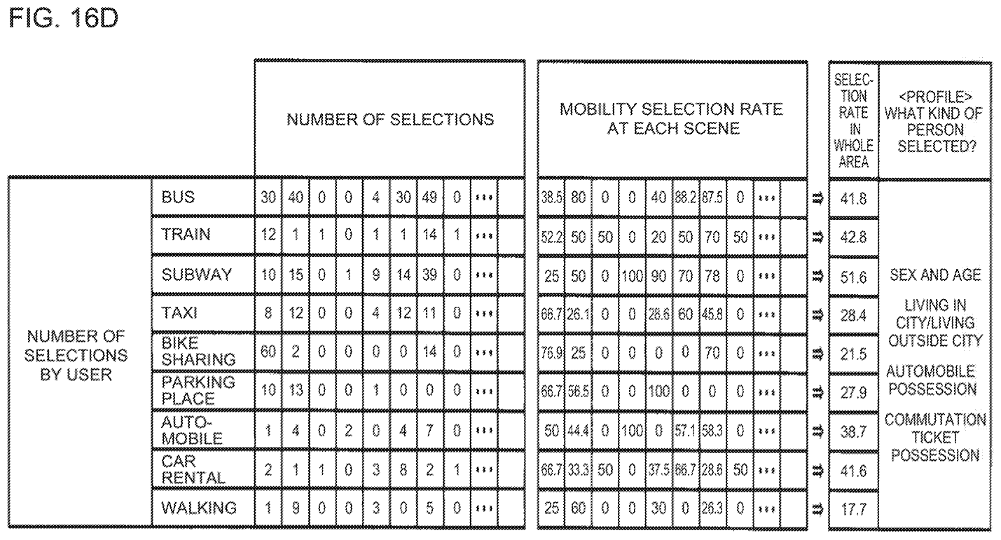

The macro data generation unit 206 generates output data (referred to as “macro data”, hereinafter) for knowing a variety of tendency and the like relevant to the movement of the user from macroperspective, based on history data that is accumulated in the route search result history storage unit 207 and that indicates multimodal route search results by the route search unit 201 corresponding to route search requests from a plurality of users, that is, based on a record group of past multimodal route search results. Details of a generation method and the like for the macro data will be described later (see FIG. 15A, FIG. 15B, FIG. 16A, FIG.16B, FIG. 16C and FIG. 16D).

The macro data generation unit 206 may be provided in another server that is communicably connected with the center server 20 having the multimodal route search function, for example, in a dedicated server for the macro data generation.

As described above, the route search result history storage unit 207 accumulates the multimodal route search result by the route search unit 201. Specifically, whenever the route search unit 201 outputs the multimodal route search result corresponding to the route search request, a record corresponding to the multimodal route search result is stored in the route search result history storage unit 207, so that the route search result history storage unit 207 holds a record group (that is, a database) of past multimodal route search results.

The route search result history storage unit 207 may be provided in another server that is communicably connected with the center server 20 having the multimodal route search function, for example, in a dedicated server for the accumulation of the history data of the multimodal route search result or the above-described dedicated server for the macro data generation. The same goes for the macro data storage unit 208 described below.

The macro data storage unit 208 stores the macro data generated by the macro data generation unit 206.

Details of Route Search Request Method

Next, details of the method by which the user requests the multimodal route search to the center server 20 using the portable terminal 10 will be described with reference to FIG. 4, FIG. 5A, FIG. 5B, FIG. 6A, FIG.6B and FIG. 6C.

First, FIG. 4 is a diagram for describing an exemplary user handling method for requesting the multimodal route search. Specifically, FIG. 4 is a diagram showing an exemplary application screen (an application screen 400) for sending the route search request in the route search application from the portable terminal 10 to the center server 20.

As shown in FIG. 4, the application screen 400 to be displayed on the display device 16 of the portable terminal 10 includes a route search button 401, a departure place box 402, a destination place box 403, a stop-off place box 404, a stay time setting menu 405, a departure hour setting menu 406, a map display region 407, and a route search execution button 408.

The route search button 401 is disposed on the leftmost side of a button group provided in a fixed display region that is laterally set at a lower end position on all application screens for the route search application. The user can cause the display device 16 to display the application screen 400, by performing a handling of designating and deciding the route search button 401 (for example, a touch handling of a corresponding position on the touch panel) on an arbitrary application screen for the route search application.

The departure place box 402 is used for setting the departure place in the multimodal route search. The user can set a desired departure place in the departure place box 402. For example, in the departure place box 402, the current place may be set as a default setting. The current place may be the current position of the portable terminal 10 that is measured by a global navigation satellite system (GNSS) device mounted on the portable terminal 10, as exemplified by a global positioning system (GPS) device (see FIG. 3). It is allowable to adopt a configuration in which the user inputs a facility name or a keyword corresponding to an arbitrary departure place in the departure place box 402, and thereby a list of destination place candidates corresponding to the input facility name or keyword is displayed, so that the user can select (set) a desired destination place from the displayed list. The same goes for the destination place box 403 and the stop-off place box 404 described below.

The destination place box 403 is used for setting the destination place in the multimodal route search. The user can set a desired destination place in the destination place box 403.

The stop-off place box 404 is used for setting the stop-off place in the multimodal route search. The user can set a desired stop-off place in the stop-off place box 404.

The setting of the stop-off place may be omitted.

The stay time setting menu 405 is used for setting a stay time at the stop-off place in the multimodal route search. For example, the user performs a handling of designating and deciding the stay time setting menu 405, and thereby a drum type setting menu for setting the stay time is superimposed and displayed on the application screen, so that the user can set the stay time at the stop-off place set in the stop-off place box 404, through the drum-type setting menu. The same goes for the setting of the departure hour in the departure hour setting menu 406 described below. In the example of FIG. 4, the stay time is set to “1 H 30 MIN”, in the stay time setting menu 405.

The setting of the stay time at the stop-off place may be omitted.

The departure hour setting menu 406 is used for setting a departure hour at the departure place in the multimodal route search. Thereby, the user can set the departure hour at the departure place set in the departure place box 402. In the example of FIG. 4, the departure hour is set to “DEPARTING RIGHT NOW” corresponding to the current hour.

In the map display region 407, there is displayed a map image of an area containing the departure place, the destination place and the stop-off place that are set in the departure place box 402, the destination place box 403 and the stop-off place box 404. Further, on the map image of the map image display region 407, images as marks are superimposed and displayed at positions on the map image that correspond to the departure place, the destination place and the stop-off place. Thereby, the user can know a relation on the map among the departure place, the destination place and the stop-off place.

The route search execution button 408 is used for executing the multimodal route search in line with contents set in the departure place box 402, the destination place box 403, the stop-off place box 404, the stay time setting menu 405 and the departure hour setting menu 406. Specifically, by performing a handling of designating and deciding the route search execution button 408, the user can send the route search request including the contents set in the departure place box 402, the destination place box 403, the stop-off place box 404, the stay time setting menu 405 and the departure hour setting menu 406, from the portable terminal 10 to the center server 20.

Thus, the user can set a search specification in the multimodal route search, through the application screen 400, and can cause the center server 20 to perform the multimodal route search in line with the set search specification.

Subsequently, FIG. 5A and FIG. 5B are diagrams for describing an alternative exemplary user handling method for requesting the multimodal route search. Specifically, FIG. 5A is a diagram showing a specific example (an application screen 500) of an application screen for performing a retrieval (referred to as an “event-spot retrieval”, hereinafter) relevant to an event or a POI (spot) in the route search application. FIG. 5B is a specific example of an application screen indicating details of the event or spot selected from retrieval results on the application screen 500, and an alternative example (an application screen 510) of the application screen for sending the route search request in the route search application from the portable terminal 10 to the center server 20.

The application screen 510 in FIG. 5B shows the whole region that can be displayed on the display device 16 by a scroll handling of the input device 17 of the portable terminal 10. On the actual display device 16, only a portion in the longitudinal direction of the application screen 510 is displayed.

As shown in FIG. 5A, the application screen 500 to be displayed on the display device 16 of the portable terminal 10 includes an event-spot retrieval button 501, an event-spot retrieval box 502, a retrieval category selection button group 503 and a retrieval result display region 504.

Similarly to the route search button 401 in FIG. 4, the event-spot retrieval button 501 is provided in the fixed display region on all application screens for the route search application, and is disposed at the second left position of the button group in the fixed display region. The user can cause the display device 16 to display the application screen 500, by performing a handling of designating and deciding the event-spot retrieval button 501 on an arbitrary application screen for the route search application.

The event-spot retrieval box 502 is used for inputting a keyword with which the user causes the portable terminal 10 to perform the event-spot retrieval and that indicates a place that the user wants to visit, a thing that the user wants to do, or the like.

The retrieval category selection button group 503 is used for selecting a category condition when the event-spot retrieval is performed in line with the keyword input in the event-spot retrieval box 502. In the example of FIG. 5A, there are provided four retrieval category selection buttons corresponding to the respective categories of “PLAYING”, “OUTING”, “SHOPPING” and “EATING”. The user inputs the keyword in the event-spot retrieval box 502, and then performs a handling of designating and deciding one of the four retrieval category selection buttons. Thereby, the user can cause the portable terminal 10 to perform the event-spot retrieval in line with the category condition corresponding to the input keyword and the handled retrieval category selection button. On this occasion, for example, the portable terminal 10 can perform the event-spot retrieval, through a Web API for event-POI retrieval that is published by the event-POI related server 58.

On the retrieval result display region 504, the retrieval result of the event-spot retrieval is displayed. Specifically, on the retrieval result display region 504, brief information about events, spots or the like picked up by the event-spot retrieval (for example, images of the events or spots, names of the events or spots, information relevant to opening places of the events or locations of the spots) may be displayed as icons. The display content on the retrieval result display region 504 can be scrolled in the longitudinal direction by a scroll handing of the input device 17 by the user. Thereby, while performing the scroll handling, the user can check the brief information about the retrieval result, that is, at least one of a plurality of events and a plurality of spots that are output by the event-spot retrieval. The same goes for a display manner (see FIG. 6B) of a retrieval result of a peripheral information retrieval described later. The user performs a handing of designating and deciding one event or spot from the plurality of events or spots displayed on the retrieval result display region 504, and thereby, the user can cause the display content of the display device 16 to transition to the application screen 510 on which detailed information about the designated event or spot is displayed.

As shown in FIG. 5B, the application screen 510 to be displayed on the display device 16 of the portable terminal 10 includes an event-spot detail display region 511, a map display region 512 and a route search execution button 513.

The event-spot detail display region 511 is used for displaying the detailed information about the event or spot designated (selected) from the retrieval result of the application screen 500 by the user handling.

On the map display region 512, there is displayed a map image containing the opening place of the event for which the detailed information is displayed on the event-spot detail display region 511 or the location of the spot for which the detailed information is displayed on the event-spot detail display region 511. On the map image, an image as a mark indicating the opening place of the event or the location of the spot is superimposed and displayed. Thereby, the user can know the peripheral geographic information including the opening place of the event or the location of the spot.

The route search execution button 513 is used for executing a multimodal route search in which the destination place is set to the opening place of the event for which the detailed information is displayed on the event-spot detail display region 511 or the location of the spot for which the detailed information is displayed on the event-spot detail display region 511. For example, when the user performs a handling of designating and deciding the route search execution button 513, the portable terminal 10 may send, to the center server 20, the route search request in which the departure place is set to the current position of the user, that is, the current position of the portable terminal 10 that is measured by the GNSS device mounted on the portable terminal 10, the destination place is set to the opening place of the event or the location of the spot and the departure hour is set to the current hour. Further, when the user performs the handling of designating and deciding the route search execution button 513, the display content of the display device 16 may transition to the application screen 400 on which the opening place of the event or the location of the spot has been already set in the destination place box 403.

Thus, the user can set the destination place to the opening place of the event or the location of the spot that is obtained through the application screens 500, 510 as the retrieval result of the event-spot retrieval, and can cause the center server 20 to perform the multimodal route search.

Subsequently, FIG. 6A to FIG. 6C are diagrams for describing a further alternative exemplary user handling method for requesting the multimodal route search. Specifically, FIG. 6A is a diagram showing a specific example (an application screen 600) of an application screen on which a map image is displayed. The map image contains a part or a whole of the route of a route candidate as the multimodal route search result in the route search application. FIG. 6B is a diagram showing a specific example (an application screen 610) of an application screen on which a retrieval result for the peripheral information is displayed. In the retrieval of the peripheral information, the geographic condition is the range of the map image that is displayed on the application screen 600. FIG. 6C is a specific example of an application screen showing details of an event or the like selected from the retrieval result for the peripheral information on the application screen 610, and is an alternative example (an application screen 620) of the application screen for sending the route search request in the route search application from the portable terminal 10 to the center server 20.

The application screen 600 in FIG. 6A is displayed on the display device 16, in response to a predetermined operation by the user on a later-described application screen 810 (see FIG. 8B) corresponding to detailed display of the route candidate as the multimodal route search result. The application screen 620 in FIG. 6C shows the whole region that can be displayed on the display device 16 by a scroll handling of the input device 17 of the portable terminal 10. On the actual display device 16, only a portion in the longitudinal direction of the application screen 620 is displayed.

As shown in FIG. 6A, the application screen 600 to be displayed on the display device 16 of the portable terminal 10 includes a map display region 601 and a retrieval category selection button group 602.

The map display region 601 is used for displaying a map image of a range containing a part or a whole of the route of one route candidate that is included in the multimodal route search result. In the example of FIG. 6A, a map image of a range containing a transfer station (“ΔΔΔ STA”) on the route of the route candidate is displayed on the map display region 601.

The retrieval category selection button group 602 is superimposed and displayed at a lower end portion of the map display region 601, and is used for selecting a category condition at the time of a retrieval (referred to as a “peripheral information retrieval”, hereinafter) for the peripheral information in which the geographic condition is the range of the map image that is displayed on the map display region 601. In the example of FIG. 6A, there are provided eight retrieval category selection buttons corresponding to the respective categories of “PLAYING”, “OUTING”, “SHOPPING”, “EATING”, “PARKING PLACE”, “PORT”, “BUS STOP” and “CAR RENTAL”. “PORT” means a cycle port of the cycle sharing. The user performs a handing of designating and deciding one of the eight retrieval category selection buttons. Thereby, the user can cause the portable terminal 10 to perform the peripheral information retrieval in line with the geographic condition corresponding to the range of the map image and the category condition corresponding to the handled retrieval category selection button. On this occasion, for example, the portable terminal 10 can perform the peripheral information retrieval, through Web APIs for retrievals of the bus stop of fixed-route bus, the service office of the car rental, the cycle port of the cycle sharing and the parking place that are published by the fixed-route bus related server 30, the car rental related server 46, the cycle sharing related server 48 and the parking place related server 56. Thereby, the display content to be displayed on the display device 16 of the portable terminal 10 transitions from the application screen 600 to the application screen 610.

As shown in FIG. 6B, the application screen 610 to be displayed on the display device 16 of the portable terminal 10 includes a map display region 611 and a retrieval result display region 612.

The map display region 611 is used for displaying a map image of a range containing a facility or the like corresponding to the retrieval result of the peripheral information retrieval. On the map image of the map display region 611, mark images 611A indicating the opening places of events or the locations of facilities that are output as the retrieval result of the peripheral information retrieval are superimposed and displayed.

The retrieval result display region 612 is used for displaying the retrieval result of the peripheral information retrieval. Specifically, on the retrieval result display region 612, brief information about events, facilities or the like picked up by the peripheral information retrieval may be displayed as a list. The user performs a handling of designating and deciding one of a plurality of events, facilities or the like displayed on the retrieval result display region 612, and thereby, the user can cause the display content of the display device 16 to transition to the application screen 620 on which detailed information about the designated event, facility or the like is displayed.

As shown in FIG. 6C, the application screen 620 to be displayed on the display device 16 of the portable terminal 10 includes a peripheral information detail display region 621, a map display region 622, a destination place setting button 623 and a stop-off place setting button 624.

The peripheral information detail display region 621 is used for displaying detailed information about the event, the facility or the like that is designated (selected) from the retrieval result on the application screen 610 by a user handling.

On the map display region 622, there is displayed a map image containing, for example, the opening place of the event for which the detailed information is displayed on the peripheral information detail display region 621 or the location of the facility or the like for which the detailed information is displayed on the peripheral information detail display region 621. On the map image, a mark image 622A indicating the opening place of the event, the location of the facility or the like is superimposed and displayed. Thereby, the user can know the peripheral geographic information including the opening place of the event or the location of the spot.

The destination place setting button 623 and the stop-off place setting button 624 are used for setting the opening place of the event for which the detailed information is displayed on the peripheral information detail display region 621 and the location of the facility or the like for which the detailed information is displayed on the peripheral information detail display region 621, as the destination place and the stop-off place respectively, and executing the multimodal route search again. For example, when the user performs a handling of designating and deciding the destination place setting button 623 or the stop-off place setting button 624, the portable terminal 10 may send, to the center server 20, the route search request in which only the condition of the destination place or stop-off place is changed to the opening place of the event or the location of the facility or the like while the other conditions are the same as those in the original multimodal route search. Further, when user performs a handling of designating and deciding the destination place setting button 623, the display content of the display device 16 may transition to the application screen 400 on which the opening place of the event or the location of the facility or the like has been already set in the destination place box 403 or the stop-off place 404 and the other conditions have been set so as to be the same as those in the original multimodal route search.

Thus, the user can set the destination place or the stop-off place to the opening place of the event or the location of the facility or the like that is obtained through the application screens 600 to 620 as the retrieval result of the peripheral information retrieval for the route candidate as the multimodal route search result, and can perform the multimodal route search.

Details of Multimodal Route Search Method

Next, details of the multimodal route search by the center server 20 (the route search unit 201) will be described with respect to FIG. 7. The multimodal route search method, particularly, characteristic parts of the embodiment will be mainly described below.

FIG. 7 is a diagram showing an exemplary application screen (an application screen 700) for setting the object movement means from a plurality of movement means that can be set as the object movement means in the route search application.

The route search unit 201 searches a multimodal route using one or more of the plurality of object movement means and outputs one or a plurality of route candidates, based on a search condition (for example, a condition set on the application screen 400 in FIG. 4) including the departure place and destination place corresponding to the route search request. On this occasion, the object movement means may be selected from the plurality of movement means by the user, as described above. For example, the user can select the object movement means through the application screen 700 in FIG. 7. That is, the user can change the precondition in the multimodal route search by the route search unit 201.

For example, as shown in FIG. 7, on the application screen 700, a plurality of movement means (“WALKING”, “TRAIN”, “FIXED-ROUTE BUS”, “BOAT OR WATER-BUS”, “EXPRESS TRAIN OR SHINKANSEN”, “EXPRESSWAY BUS”, “AIRPLANE”, “TAXI”, “CYCLE SHARING”, “BICYCLE”, “AUTOMOBILE”, “CAR RENTAL” and “CAR SHARING”) as candidates of the object movement means is displayed so as to be arrayed in the longitudinal direction.

Among the candidates of the object movement means, “WALKING” and “TRAIN” are fixed as the object movement means. That is, in this example, the route search unit 201 performs the multimodal route search such that the route uses one or more combinations of the object movement means that include at least “WALKING” and “TRAIN”. For the other candidates (“FIXED-ROUTE BUS”, “BOAT OR WATER-BUS”, “EXPRESS TRAIN OR SHINKANSEN”, “EXPRESSWAY BUS”, “AIRPLANE”, “TAXI”, “CYCLE SHARING”, “BICYCLE”, “AUTOMOBILE”, “CAR RENTAL” and “CAR SHARING”) of the object movement means, setting-unsetting (ON-OFF) as the object movement means is switched by a user handling of a slide switch that is provided at a side of the name of the candidate of the object movement means on the application screen 700.

The user performs a handling of set-unset for each candidate of the object movement means on the application screen 700, and then, performs a handling of designating and deciding a “COMPLETION” button that is disposed at an upper right corner of the application screen 700. Thereby, the user can send the setting content on the application screen 700 from the portable terminal 10 to the center server 20, and can adopt the setting content as a precondition (referred to as a “route search precondition”, hereinafter) of the route search by the route search unit 201.

Thus, the route search unit 201 can perform the multimodal route search, based on the retrieval condition that is set in the route search request received from the portable terminal 10 and the route search precondition that is reflected in the center server 20 through the application screen 700 or the like.

In this example (FIG. 7), the railway is divided into “TRAIN” and “EXPRESS TRAIN OR SHINKANSEN” as candidates of the object movement means. However, “TRAIN” and “EXPRESS TRAIN OR SHINKANSEN” may be integrated to one item. Further, in this example, the boat and the water-bus are integrated and are treated as one object movement means. However, the boat and the water-bus may be treated as individual candidates of the object movement means.

In the case of searching a candidate route including the use of the share-type movement means, the route search unit 201 may limit a use part on the movement route from the departure place to the destination place. Specifically, the route search unit 201 may perform the route search from the departure place to the destination place that includes the use of the share-type movement means, such that the use of the share-type movement means is limited to at least one of the start of the use at the departure place or the periphery of the departure place and the use for arrival at the destination place or the periphery of the destination place. On this occasion, the periphery of the departure place and the periphery of the destination place mean ranges of equal to or shorter than a predetermined distance (for example, two kilometers) from the departure place and the destination place, respectively.

The share-type movement means has a relatively high flexibility for use selection in the route search. For example, in the case where the route search unit 201 performs the route search on the premise of the movement by the private-use automobile or bicycle, it is necessary to secure a parking place or a bicycle parking place, and therefore, the route search unit 201 often performs the route search such that the user moves from the departure place to the destination place basically using only the automobile or the bicycle. On the other hand, for the share-type movement means, in many cases, access points (for example, service offices of the car rental, stations of the car sharing, cycle ports of the cycle sharing, and the like) for the transport machine are set at various places, or the user can ride or alight anywhere (for example, the taxi, the ride share and the like). Therefore, it is possible to relatively easily realize a use form of using the share-type movement means only in a part of the route between the departure place and the destination place. Further, unlike the bus, the train and the like that have relatively large riding capacities, for the share-type movement means, the movement route is not previously specified, and therefore, movement flexibility is also high. Accordingly, when the share-type movement means is included in the movement means as the route search object in the multimodal route search, there is a possibility that the route search cannot be completed within a realistic time.

In contrast, in the case where the multimodal route search is performed such that a part where the share-type movement means is a use object on the route from the departure place to the destination place is limited as described above, it is possible to restrain increase in combination patterns including other movement means such as a public transportation. Further, since one of the start point and the end point of the share-type movement means is limited to the departure place or the periphery of the departure place, or to the destination place or the periphery of the destination place, it is possible to decrease the degree of the flexibility of the movement route compared to a configuration in which both the start point and the end point are free. Accordingly, the center server 20 (the route search unit 201) can restrain the increase in combination patterns including other movement means such as a public transportation, and can perform the multimodal route search within a realistic time.

Specifically, the share-type movement means as the object movement means may include at least one of the car rental, the car sharing, the cycle sharing, the ride sharing, the taxi and the like, as described above.

Thereby, the center server 20 (the route search unit 201) can complete the multimodal route search including the car rental, the car sharing, the cycle sharing, the ride sharing, the taxi or the like as specific share-type movement means, within a realistic time.

More specifically, in the case where the share-type movement means is the car rental, the route search unit 201 may perform the multimodal route search from departure place to the destination place that includes the use of the car rental such that the use of the car rental is limited to at least one of the start of the use at a service office of the car rental in the periphery of the departure place and the end of the use at a service office in the periphery of the destination place. In the case where the share-type movement means is the car sharing, the route search unit 201 may perform the multimodal route search from the departure place to the destination place that includes the use of the car sharing, such that the use of the char sharing is limited to at least one of the start of the use at a car sharing station in the periphery of the departure place and the end of the use at a car sharing station in the periphery of the destination place. In the case where the share-type movement means is the cycle sharing, the route search unit 201 may perform the multimodal route search from the departure place to the destination place that includes the use of the cycle sharing, such that the use of the cycle sharing is limited to at least one of the start of the use at a cycle port in the periphery of the departure place and the end of the use at a cycle port in the periphery of the destination place. That is, the route search unit 201 may perform the multimodal route search from the departure place to the destination place that includes the use of the share-type movement means, such that the use of the car rental, the car sharing or the cycle sharing is limited to at least one of the start of the use at a transport machine access point corresponding to the periphery of the departure place and the end of the use at a transport machine access point corresponding to the periphery of the destination place.

Thereby, the center server 20 (the route search unit 201) can perform the multimodal route search that includes the use of the share-type movement means, in accordance with the characteristic of the share-type movement means such as the car rental, the car sharing and the cycle sharing, that is, the characteristic that it is necessary to ride or alight at the access point.

Further, the route search unit 201 may perform the multimodal route search from the departure place to the destination place that includes the use of the share-type movement means, such that the use of the ride sharing or the taxi is limited to at least one of the start of the use at the departure place and the end of the use at the destination place.

Thereby, the center server 20 (the route search unit 201) can perform the multimodal route search that includes the share-type movement means, in accordance with the characteristic of the share-ride movement means such as the ride sharing and the taxi, that is, the characteristic that the user can ride or alight anywhere.

Further, an upper limit (referred to as a “search upper-limit distance”, hereinafter) of use distance in the multimodal route search may be set for each of the object movement means. For example, for the taxi, the search upper-limit distance (for example, 100 kilometers) may be set. This is because, for the taxi, when the distance is too long, the fare exceeds a realistic fare that the user may pay, and there is a possibility that the provision of the route candidate becomes meaningless. Further, for the cycle sharing or the walking, the search upper-limit distance (for example, 10 kilometers) may be set. This is because, for the cycle sharing or the walking, when the use distance is too long, there is a possibility that the provision of the route candidate becomes meaningless, because of the limit of user's physical strength.

Details of Display Method for Route Search Result

Next, details of the method for displaying the route search result on the portable terminal 10 will be described with reference to FIG. 8A, FIG. 8B and FIG. 9.

FIG. 8A and FIG. 8B are diagrams showing exemplary display screens for the multimodal route search result. Specifically, FIG. 8A is a diagram showing an exemplary display screen (an application screen 800) on which a plurality of route candidates in the multimodal route search result is listed. FIG. 8B is a diagram showing an exemplary application screen (an application screen 810) on which a detailed content of one route candidate of the plurality of route candidates in the multimodal route search result is displayed. FIG. 9 is a diagram for describing an exemplary decision method for the object movement means, in which the name of the object movement means is displayed in association with the route candidate.

Each of the application screens 800, 810 in FIG. 8A and FIG. 8B shows the whole region that can be displayed on the display device 16 by a scroll handling of the input device 17 of the portable terminal 10. On the actual display device 16, only a portion in the longitudinal direction of each of the application screens 800, 810 is displayed. Therefore, by performing the scroll handling of the input device 17 of the portable terminal 10 in the longitudinal direction, the user can view the whole region of each of the application screens 800, 810. The same goes for application screens 1000, 1200, 1300 in FIG. 10A, FIG. 12A and FIG. 13A described later.

As shown in FIG. 8A, the application screen 800 to be displayed on the display device 16 of the portable terminal 10 includes route candidate display regions 801 to 808 that are set so as to be arrayed in the longitudinal direction and that correspond to a plurality of route candidates.

On the route candidate display region 801 set at the top, there is displayed a route candidate in which the user first moves on foot from the departure place to a cycle port of the cycle sharing in the periphery of the departure place, subsequently moves by the shared cycle from the cycle port of the cycle sharing in the periphery of the departure place to a cycle port of the cycle sharing in the periphery of a riding station (“□□ LINE xx STA”) of the railway, subsequently moves from the riding station to a predetermined alighting station using two lines of the railway, and finally moves on foot from the alighting station to the destination place (see a fourth display region 801D described later).

On the route candidate display region 802 set at the second top, there is displayed a route candidate in which the user first moves by the taxi from the departure place to a riding station (“oo LINE ΔΔ STA”) of the railway, subsequently moves from the riding station to a predetermined alighting station using three lines of the railway, and finally moves on foot from the alighting station to the destination place (see a fourth display region 802D described later).

On the route candidate display region 803 set at the third top, there is displayed a route candidate in which the user first moves on foot from the departure place to a riding station (“oo LINE xx STA”) of the railway, subsequently moves from the riding station to an alighting station using three lines of the railway, and finally moves on foot from the alighting station to the destination place (see a fourth display region 803D described later).

On the route candidate display region 804 set at the fourth top, there is displayed a route candidate in which the user first moves on foot from the departure place to a bus stop (“oo LINE ΔΔ BUS STOP”) of the fixed-route bus in the periphery of the departure place, moves by the fixed-route bus from the bus stop to a riding station of the railway, subsequently moves from the riding station to a predetermined alighting station using three lines of the railway, and finally moves on foot from the alighting station to the destination place (see a fourth display region 804D described later).

On the route candidate display region 805 set at the fifth top, there is displayed a route candidate in which the user first moves on foot from the departure place to a service office of the car rental in the periphery of the departure place, moves by the rented car from the service office of the car rental to a service office of the car rental in the periphery of the destination place, and finally moves on foot from the service office of the car rental in the periphery of the destination place to the destination place (see a fourth display region 805D described later).

On the route candidate display region 806 set at the sixth top, there is displayed a route candidate in which the user first moves on foot from the departure place to a car sharing station in the periphery of the departure place, moves by the shared car from the car sharing station in the periphery of the departure place to a car sharing station in the periphery of the destination place, and finally moves on foot from the car sharing station in the periphery of the destination place to the destination place (see a fourth display region 806D described later).

On the route candidate display region 807 set in the second bottom, there is displayed a route candidate in which the user moves by automobile from the departure place to the destination place (see a fourth display region 807D described later).

On the route candidate display region 808 set at the bottom, there is displayed a route candidate in which the user moves by bicycle from the departure place to the destination place (see a fourth display region 808D described later).

The six route candidates corresponding to the route candidate display regions 801 to 806 are sorted depending on a common condition that is set regardless of the plurality of object movement means (referred to as a “common condition”, hereinafter), for example, in ascending order according to arrival time, in ascending order according to fee or in ascending order according to the number of transfers, and are displayed from the top. In the example of FIG. 8A, the six route candidates are sorted and displayed from the top in ascending order according to the time to the arrival at the destination.

On the other hand, each of the two route candidates corresponding to the route candidate display regions 807, 808 depends on a condition (referred to as a “unique condition”, hereinafter) that is specified for each of the object movement means to be used in the route candidate, regardless of the above-described common condition, and the display order of the two route candidates in the eight route candidates are fixed so as to be later (in this example, lower) than the other six route candidates. This is because it is thought that there is a relatively low possibility that the user of the multimodal route search preferentially selects the route search result with the private-use automobile or bicycle. More specifically, this is because, in consideration of this point, the route candidate using only the private-use automobile or bicycle only needs to be provided to the user for comparison with the other route candidates. That is, the search result delivery unit 202 may generate the route search result delivery data in which the display order of a particular route candidate using only the automobile or bicycle in the plurality of route candidates is fixed so as to be later than the display order of the route candidates other than the particular route candidate, and may deliver the route search result delivery data to the portable terminal 10.

The display order between the route candidate using only the automobile and the route candidate using only the bicycle may be an order of the route candidate using only the automobile and the route candidate using only the bicycle as shown in FIG. 8A, or may be an order of the route candidate using only the bicycle and the route candidate using only the automobile. Further, the display order between the route candidate using only the automobile and the route candidate using only the bicycle may be decided depending on the above-described common condition (for example, in ascending order according to arrival time or in ascending order according to fee).

Further, depending on the unique condition that is specified for each of particular object movement means other than the automobile or the bicycle, the display specification of the particular route candidate using the particular object movement means may be decided.

For example, as for a particular route candidate using the taxi, in the case where the use distance of the taxi in the particular route candidate is relatively short, the search result delivery unit 202 causes the display device 16 of the portable terminal 10 to display the particular route candidate as the route search result. On this occasion, the display order of the particular route candidate in the plurality of route candidates may be decided based on the common condition. That is, the display specification of the particular route candidate may be decided by preferentially applying the unique condition and then applying the common condition. The same goes for other particular route candidates. On the other hand, in the case where the use distance of the taxi is relatively long, the search result delivery unit 202 may cause the display device 16 of the portable terminal 10 not to display the particular route candidate as the route search result. Specifically, in the case where the use distance of the taxi in the particular route candidate is shorter than a predetermined threshold (referred to as a “first threshold”, hereinafter) (for example, 15 kilometers), the search result delivery unit 202 causes the display device 16 of the portable terminal 10 to display the particular route candidate as the route search result, and in the case where the use distance of the taxi in the particular route candidate is equal to or longer than the first threshold, the search result delivery unit 202 may cause the display device 16 of the portable terminal 10 not to display the particular route candidate as the route search result. This is because when the use distance of the taxi increases to some extent, the possibility that the user selects the particular route candidate can greatly decrease because of the fee and the like. On this occasion, the particular route candidate may be a route candidate using a combination of the taxi and other movement means, or may be a route candidate using only the taxi. Further, similarly to the case of the taxi, as for a particular route candidate using the ride sharing, whether to cause the display device 16 of the portable terminal 10 to display the particular route candidate as the route search result may be decided depending on the same fixed condition (depending on whether the use distance of the ride sharing is equal to or longer than the first threshold). That is, in the case where the use distance of the taxi or the ride sharing in the particular route candidate using at least one of the taxi and the ride sharing is shorter than the first threshold, the search result delivery unit 202 may cause the display device 16 of the portable terminal 10 to display the particular route candidate, and in the case where the use distance of at least one of the taxi and the ride sharing in the particular route candidate is equal to or longer than the first threshold, the search result delivery unit 202 may cause the display device 16 of the portable terminal 10 not to display the particular route candidate as the route search result. Further, in the case where the use distance of at least one of the taxi and the ride sharing in the particular route candidate using at least one of the taxi and the ride sharing is relatively long, the search result delivery unit 202 may set the display order to a later order than an order decided based on the common condition, instead of causing the display device 16 of the portable terminal 10 not to display the particular route candidate.

Further, for example, as for a particular route candidate using the walking, in the case where the use distance of the walking in the particular route candidate is relatively short, specifically, is shorter than a predetermined threshold (referred to as a “second threshold”, hereinafter) (for example, 1.2 kilometers), the search result delivery unit 202 causes the display device 16 of the portable terminal 10 to display the particular route candidate as the route search result. On the other hand, in the case where the use distance of the walking in the particular route candidate is relatively long, namely, is equal to or longer than the second threshold, the search result delivery unit 202 may cause the display device 16 of the portable terminal 10 not to display the particular route candidate as the route search result. This is because when the use distance is relatively long in the case of the route candidate using the walking, the possibility of the selection by the user can greatly decrease because of physical exhaustion, required time and the like. Further, in the case where the use distance of the walking in the route candidate using the walking is relatively long, the search result delivery unit 202 may set the display order to a later order than an order decided based on the common condition, instead of causing the display device 16 of the portable terminal 10 not to display the particular route candidate.

Further, for example, in the case where the transfer interval between public transportations of the same kind or between public transportations different from each other is relatively short, specifically, is shorter than a predetermined threshold (referred to as a “third threshold”, hereinafter), in a particular route candidate using the object movement means (public transportation) for which the operation plan including the operation route and the operation hour is previously specified, as exemplified by the railway, the bus, the airplane, and the boat, the search result delivery unit 202 causes the display device 16 of the portable terminal 10 to display the particular route candidate as the route search result. On the other hand, in the case where the transfer interval between public transportations is relatively long, namely, is equal to or longer than the third threshold, the search result delivery unit 202 may cause the display device 16 of the portable terminal 10 not to display the particular route candidate as the route search result. This is because when the transfer interval is relatively long, convenience for the user significantly decreases and the possibility of the selection by the user can decrease. Further, in the case where the transfer interval between public transportations in the route candidates using the public transportations is relatively long, the search result delivery unit 202 may set the display order to a later order than an order decided based on the common condition, instead of causing the display device 16 of the portable terminal 10 not to display the particular route candidate.

Thus, the search result delivery unit 202 causes the display device 16 of the portable terminal 10 to display a particular route candidate that is of the plurality of route candidates and that uses a particular movement means, based on a display specification that is decided depending on the unique condition specified for the particular object movement means of the plurality of object movement means and that includes at least one of the display order in the plurality of route candidates and information of whether to display the particular route candidate.

Thereby, although the criterion by which the user selects one route candidate from the plurality of route candidates can vary depending on the object movement means to be used in the route candidate, the center server 20 can adopt the unique condition for the particular object movement means to the display specification of the particular route candidate using the particular object movement means. Accordingly, for example, when the unique condition for the particular object movement means is set in line with the criterion by which the user selects the particular route candidate including the particular object movement means, the center server 20 can enhance the convenience for the user when the user selects one route candidate from the plurality of route candidates.

Further, the search result delivery unit 202 may cause the display device 16 of the portable terminal 10 to display route candidates that are of the plurality of route candidates and that is other than the particular route candidate, based on a display specification that is decided depending on the common condition specified for the plurality of route candidates and that includes the display order in the plurality of route candidates, and may cause the display device 16 of the portable terminal 10 to display the particular route candidate, based on a display specification that is decided depending on the unique condition and that includes the display order in the plurality of route candidates and information of whether to display the particular route candidate.

Thereby, the center server 20 can cause the display device 16 of the portable terminal 10 to display the particular route candidate using the particular object movement means with the unique condition, on the premise that the center server 20 causes the display device 16 of the portable terminal 10 to display the plurality of route candidates with the common condition, for example, in ascending order according to required time.

Further, the search result delivery unit 202 may cause the display device 16 of the portable terminal 10 to display the particular route candidate, based on a display specification that is decided depending on the common condition and the unique condition to be applied in preference to the common condition and that includes the display order in the plurality of route candidates and information of whether to display the particular route candidate.

Thereby, for the particular route candidate using the particular object movement means, the center server 20 can preferentially apply the unique condition, and furthermore, in a situation where the common condition can be applied, the center server 20 can apply the common condition, and can cause the user terminal (the portable terminal 10) to display the particular route candidate with the common condition.

As shown in FIG. 8A, the route candidate display regions 801 to 808 include first display regions 801A to 808A, second display regions 801B to 808B, third display regions 801C to 808C, fourth display regions 801D to 808D, and fifth display regions 801E to 808E, respectively.

The first display regions 801A to 808A are laterally disposed on upper end portions (uppermost lines) in the route candidate display regions 801 to 808, respectively. On each of the first display regions 801A to 808A, there is displayed a name (including an abbreviated name, a nickname or the like) of one kind of movement means of the object movement means to be used in the corresponding route candidate. On the first display regions 807A, 808A, each of which corresponds to the route candidate using one kind of object movement means, the name of the one kind of the object movement means to be used is naturally displayed. On the first display regions 801A to 806A, each of which corresponds to the route candidate using two or more kinds of object movement means, the name of one kind of object movement means of the two or more kinds of object movement means to be used in the corresponding route candidate is displayed. That is, the search result delivery unit 202 causes the display device 16 to display the name of one kind of object movement means of the two or more kinds of object movement means, in association with the route candidate that is displayed on the display device 16 of the portable terminal 10 and that uses the two or more kinds of object movement means by the route search unit 201.

In the case where the plurality of route candidates includes the route candidate using two or more kinds of object movement means and where the plurality of route candidates is displayed so as to be simply arrayed, there is a possibility that it is difficult for the user to intuitively know by what object movement means the user moves on the route in each route candidate. Further, although it is possible to display all names of the object movement means to be used in the route candidate, when individual names of the movement means included in the route candidate are long, the display is complicated rather, and there is a possibility that it is difficult for the user to intuitively know the object movement means. Further, although it is possible to give a new name to the combination of two or more kinds of object movement means to be used in the route candidate and display the new name, it is hard to image the object movement means to be used in the route candidate from the new name, depending on the way of the naming, and as a result, there is a possibility that it is difficult for the user to intuitively know the object movement means.

In contrast, since only the name of one kind of movement means of the two or more kinds of movement means to be used in the route candidate is displayed, the user can intuitively know the object movement means. Furthermore, based on the displayed object movement means, the user can intuitively know, to some extent, the other object movement means to be used in the route candidate, for example, from the content of the route search result that is displayed on the display device 16 of the portable terminal 10. Accordingly, the center server 20 allows the user to know each object movement means in the route candidate using two or more kinds of object movement means.

For example, as shown in FIG. 9, for a plurality of object movement means, priorities may be previously specified. Then, for the route candidate using two or more kinds of object movement means, the name of highest-priority object movement means of the two or more kinds of object movement means may be displayed on the display device 16 of the portable terminal 10, in association with the route candidate.

Thereby, the priority of the object movement means that the user is likely to recognize as an object characterizing the route candidate is previously to a high priority, so that the center server 20 allows the user to more appropriately know each object movement means included in the route candidate.

Specifically, the priorities of the car sharing, the cycle sharing, the ride sharing and the car rental are set so as to be higher than the priorities of public transportations such as the airplane, the boat, the expressway bus, the express train or Shinkansen, the bus and the train.

Thereby, in association with the route candidate using the public transportation and the car rental, the car sharing, the cycle sharing, the ride sharing or the like, the center server 20 can cause the display device 16 of the portable terminal 10 to display the name of the car rental, the car sharing, the cycle sharing, the ride sharing or the like, as the object movement means characterizing the route candidate. For example, in the case of providing the car rental, the car sharing, the cycle sharing, the ride sharing or the like to the user instead of general object movement means such as the public transportation, an impression effect for the user can be higher. Accordingly, the center server 20, specifically, allows the user to know each movement means in the route candidate using the public transportation and the car rental, the car sharing, the cycle sharing or the like.

The priorities of the automobile, the bicycle and the walking are set so as to be lower than the priorities of the other object movement means.

Thereby, in association with the route candidate using the automobile, the bicycle, the walking or the like and the other object movement means, the center server 20 can cause the display device 16 of the portable terminal 10 to display the name of the other object movement means as the object movement means characterizing the route candidate.

Further, in association with the route candidate that is displayed on the display device 16 of the portable terminal 10 and that uses two or more kinds of object movement means, the center server 20 may cause the display device 16 of the portable terminal 10 to display the name of the object movement means having the longest use distance or the longest use time in the route candidate.

For example, it is thought that the movement means having the longest movement distance or the longest use time in the route search result is one of the most important concerns of the user in the selection of the route candidate to be actually used from a plurality of route candidates. Accordingly, the center server 20, specifically, allows the user to know each movement means included in the route candidate.

Further, in association with the route candidate that is displayed on the display device 16 of the portable terminal 10 and that uses two or more kinds of object movement means, the center server 20 may cause the display device 16 of the portable terminal 10 to display the name of the first object movement means that is used in the route candidate other than the walking.

For example, it is thought that the first movement means that is used in the route candidate other than the walking is one of the most important concerns of the user in the selection of the route candidate to be actually used from a plurality of route candidates. Accordingly, the center server 20, specifically, allows the user to know each movement means included in the route candidate.

Back to FIG. 8A, the second display regions 801B to 808B are laterally disposed under the first display regions 801A to 808A in the route candidate display regions 801 to 808, respectively. On each of the second display regions 801B to 808B, there are displayed a departure hour, an arrival hour and a required time in the corresponding route candidate.

The third display regions 801C to 808C are laterally disposed at central portions in the longitudinal direction of the route candidate display regions 801 to 808, respectively. On each of the third display regions 801C to 804C of the third display regions 801C to 808C, there are displayed a name (including an abbreviated name, a nickname or the like) of a riding place (for example, a station of the railway, a bus stop of the fixed-route bus or the expressway bus, an airport of the airplane, or a port of the boat) of the first public transportation that is used in the corresponding route candidate, and a departure hour of the public transportation.

Thereby, even when the first object movement means that is used in a certain route candidate is other than the public transportation, the center server 20 can give a notice of the riding place and departure hour of the first used public transportation. Accordingly, the center server 20 can enhance the convenience for the user.

Each of the third display regions 805C to 808C of the third display regions 801C to 808C is blank because the public transportation is not used in the corresponding route candidate.

The fourth display regions 801D to 808D are laterally disposed under the third display regions in the route candidate display regions 801 to 808, respectively. On each of the fourth display regions 801D to 808D, there are displayed icons corresponding to the object movement means to be used in the corresponding route candidate, in transfer order.

The fifth display regions 801E to 808E are laterally disposed on lower end portions (lowermost lines) in the route candidate display regions 801 to 808, respectively. On each of the fifth display regions 801E to 808E, there are displayed the number of transfers of the object movement means (including both transfers between object movement means of the same kind and transfers between object movement means different from each other), and a required fee.

The user performs a handling of designating (selecting) and deciding one of the route candidate display regions 801 to 808, on the application screen 800, and thereby, can cause the display content of the display device 16 to transition to a detailed screen of the route candidate corresponding to the one of the route candidate display regions 801 to 808 that is designated (selected) on the application screen 800, that is, to the application screen 810 in FIG. 8B.

As shown in FIG. 8B, the application screen 810 includes a route candidate detail display region 811 and a route guide start button 812.

On the route candidate detail display region 811, there is displayed a detailed content of one route candidate selected on the application screen 800. Specifically, on the route candidate detail display region 811, the object movement means to be used in the route candidate, the departure hour and the arrival hour are displayed so as to be arrayed in the longitudinal direction, and places for transfer between object same-kind movement means of a plurality of object movement means or between different-kind object movement means of the plurality of object movement means are displayed.

The route guide start button 812 is disposed on the route candidate detail display region 811, and is used when the user starts a route guide based on the route candidate that is displayed on the route candidate detail display region 811. The user can start the route guide by the portable terminal 10, by performing a handling of designating and deciding the route guide start button 812. On this occasion, for example, the portable terminal 10 may perform the route guide by the display of a predetermined information image on the display device 16 or by voice, while comparing position information and hour information obtained by time counting means built in the portable terminal 10, as exemplified by a GNSS device and a real time clock (RTC), the departure place and arrival place of each object movement means to be sequentially used in the route candidate, and the departure hour and arrival hour of each object movement means.

Use Method for Taxi

Next, a use method for the taxi based on a user handling on the application screen for the route search application will be described with reference to FIG. 10A and FIG. 10B.

FIG. 10A and FIG. 10B are diagrams for describing an exemplary use method for the taxi based on the multimodal route search result. Specifically, FIG. 10A is a diagram showing an exemplary application screen (an application screen 1000) for displaying a detailed content of one route candidate that is of a plurality of route candidates in the multimodal route search result and that uses the taxi. FIG. 10B is a diagram showing an exemplary application screen (an application screen 1010) for the booking of the taxi by the user.

As shown in FIG. 10A, the application screen 1000 includes a route candidate detail display region 1001, similarly to the application screen 810 in FIG. 8B.

On the route candidate detail display region 1001, there is displayed a detailed content of the route candidate that includes a taxi use portion, and on the taxi use portion, a taxi booking button 1002 is disposed. The user performs a handling of designating and deciding the taxi booking button 1002, and thereby, can cause the display content of the display device 16 of the portable terminal 10 to transition from the application screen 1000 to the application screen 1010 for booking the taxi.

As shown in FIG. 10B, the application screen 1010 includes a map image display region 1011, a booking handling guide region 1012, and a riding place decision button 1013.

On the map image display region 1011, there is displayed a map image of a vicinity of a departure place of the taxi in the route candidate displayed on the application screen 1000.

The booking handling guide region 1012 is superimposed and displayed on a lower end portion of the map image display region 1011. On the booking handling guide region 1012, there is displayed character information for a handling guide that prompts the user to decide a taxi riding place on the map image of the map image display region 1011.

The riding place decision button 1013 is disposed on a right end portion of the booking handling guide region 1012 so as not to overlap with the character information for the handling guide, and is used when the user decides (fixes) the riding place.

The user performs a handling of designating a desired taxi riding place on the map image and designating and deciding the riding place decision button 1013, through the input device 17 of the portable terminal 10. Thereby, the user can fix the riding place, and for example, can send a taxi booking request corresponding to a taxi departure hour specified in the route candidate, from the portable terminal 10 to the center server 20.

Thus, the user, for example, does not need to start a browser, a dedicated application or the like in the portable terminal 10, to book the taxi for a taxi company, and the user can complete the booking of the taxi on the applications screens 1000, 1010 relevant to the display of the route candidate in the multimodal route search result. Accordingly, it is possible to enhance the convenience for the user.

Similarly to the case of the taxi, in the case of the ride sharing, the car rental, the car sharing, the cycle sharing or the like as the object movement means, it is allowable to adopt a configuration in which the use booking can be performed by a handling on an application screen relevant to the route candidate in the multimodal route search result.

Viewing Method for Parking Place Information

Next, a viewing method for the parking place information based on a user handling on an application screen for the route search application will be described with reference to FIG. 11A and FIG. 11B.

FIG. 11A and FIG. 11B are diagrams for describing an exemplary viewing method for the parking place information based on the multimodal route search result. Specifically, FIG. 11A is a diagram showing an exemplary application screen (an application screen 1100) for displaying a detailed content of one route candidate that is of a plurality of route candidates in the multimodal route search result and that uses the automobile. FIG. 11B is a diagram showing an exemplary application screen (an application screen 1110) on which the parking place information is displayed.

On the application screen 1100, a route candidate using a combination of the automobile and other object movement means may be displayed.

As shown in FIG. 11A, the application screen 1100 includes a route candidate detail display region 1101, similarly to the application screen 810 in FIG. 8B.

On the route candidate detail display region 1101, there is displayed a detailed content of the route candidate that includes an automobile use portion, and on the automobile use portion, a parking place information viewing button 1102 is displayed. The user performs a handling of designating and deciding the parking place information viewing button 1102, and thereby, can cause the display content of the display device 16 of the portable terminal 10 to transition from the application screen 1100 to the application screen 1110 for viewing the parking place information.

As shown in FIG. 11B, the application screen 1110 includes a map image display region 1111, a parking place brief information display region 1112 and a detail display button 1113.

On the map image display region 1111, there is displayed a map image of a vicinity of an arrival place of the automobile in the route candidate displayed on the application screen 1100, and on the map image, mark images 1111A indicating positions of parking places are superimposed and displayed.

The parking place brief information display region 1112 is superimposed and disposed on a lower end portion of the map image display region 1111. On the parking place brief information display region 1112, there is displayed brief information (for example, the facility name of the parking place, available hour, the maximum number of parking spots, fee, and the like) about one parking place that is selected from the parking places shown by the mark images 1111A on the map image.

The user performs a handling of designating (selecting) and deciding one mark image 1111A on the map image, through the input device 17 of the portable terminal 10, and thereby, can display the brief information about the parking place corresponding to the selected mark image 1111A, on the parking place brief information display region 1112.

The detail display button 1113 is used for causing the display device 16 of the portable terminal 10 to display detailed information about the parking place for which the brief information is displayed on the parking place brief information display region 1112. Thereby, the user can view the detailed information about the parking place, by performing a handling of designating and deciding the detail display button 1113.

Thus, the user, for example, does not need to start a browser, a dedicated application or the like in the portable terminal 10, to access the parking place information, and can view the parking place information, by a handling on the application screens 1100, 1110 relevant to the display of the route candidate using the automobile in the multimodal route search result. Accordingly, it is possible to enhance the convenience for the user.

The parking place information viewing button 1102, similarly, may be displayed on a car rental use portion or car sharing use portion of an application screen on which a detailed content of a route candidate using the car rental or the car sharing is displayed. Thereby, the user can view the parking place information, by a handling on an application screen relevant to the display of the route candidate using the car rental or the car sharing in the multimodal route search result. Accordingly, it is possible to enhance the convenience for the user.

Use Method for Cycle Sharing

Next, a use method for the cycle sharing based on a user handling on an application screen for the route search application will be described with reference to FIG. 12A and FIG. 12B.

FIG. 12A and FIG. 12B are diagrams for describing an exemplary use method for the cycle sharing based on the multimodal route search result. Specifically, FIG. 12A is a diagram showing an exemplary application screen (an application screen 1200) for displaying a detailed content of one route candidate that is of a plurality of route candidates in the multimodal route search result and that uses the cycle sharing. FIG. 12B is a diagram showing an exemplary application screen (an application screen 1210) when the user uses the cycle sharing.

As shown in FIG. 12A, the application screen 1200 includes a route candidate detail display region 1201, similarly to the application screen 810 in FIG. 8B.

On the route candidate detail display region 1201, there is displayed a detailed content of the route candidate that includes a cycle sharing use portion, and on the cycle sharing use portion, an availability check button 1202 is disposed. The user performs a handling of designating and deciding the availability check button 1202, and thereby, can cause the display content of the display device 16 of the portable terminal 10 to transition from the application screen 1200 to the application screen 1210 for checking information (referred to as “availability information”, hereinafter) relevant to the availability of the cycle port of the cycle sharing.

As shown in FIG. 12B, the application screen 1210 includes a map image display region 1211, a cycle port information display region 1212 and a use button 1213.

On the map image display region 1211, there is displayed a map image of a vicinity of a departure place of the cycle sharing in the route candidate displayed on the application screen 1200, and on the map image, mark images 1211A indicating positions of cycle ports are superimposed and displayed.

The cycle port information display region 1212 is superimposed and disposed on a lower portion of the map image display region 1211. On the cycle port information display region 1212, there is displayed information (referred to as “cycle port information”, hereinafter) about one cycle port that is selected from the cycle ports shown by the mark images 1211A on the map image (for example, the name of the cycle port, available hour, the nearest facility, and availability information such as the number of available bicycles).

The user performs a handling of designating (selecting) and deciding one mark image 1211A on the map image, through the input device 17 of the portable terminal 10, and thereby, can display the cycle port information corresponding to the selected mark image 1211A, on the cycle port information display region 1212.

The use button 1213 is used for actually using the shared cycle at the cycle port for which the cycle port information is displayed on the cycle port information display region 1212. Specifically, when the user performs a handling of designating and deciding the use button 1213, the portable terminal 10 starts an application (referred to as a “cycle sharing application”, hereinafter) for using the cycle sharing installed in the auxiliary storage device 12, or starts the browser to access the homepage of the cycle sharing. Then, the portable terminal 10 transfers information relevant to the cycle port that the user hopes to use, to the cycle sharing application or the like. Thereby, the user can use the cycle sharing, by a handling on the cycle sharing application or the homepage of the cycle sharing.

Thus, the user, for example, does not need to start a browser, a dedicated application or the like in the portable terminal 10, to access the information relevant to the cycle sharing. Accordingly, the multimodal route providing system 1 (the route search application of the portable terminal 10) can assist the use of the cycle sharing by the user, in response to a handling on the application screens 1200, 1210 relevant to the display of the route using the cycle sharing in the multimodal route search result.

By the same method as the method for the cycle sharing, the multimodal route providing system 1 (the route search application of the portable terminal 10) may assist the use of the taxi, the ride sharing, the car rental, the car sharing or the like, in response to a handling on an application screen relevant to the display of the route candidate in the multimodal route search result.

Viewing Method for Fixed-Route Bus Position Information and Purchase-Use Method for Fixed-Route Bus Ticket

Next, a viewing method for fixed-route bus position information and a purchase-use method for a fixed-route bus ticket based on a user handling on the application screen for the route search application will be described with reference to FIG. 13A and FIG. 13B.

FIG. 13A and FIG. 13B are diagrams for describing an exemplary viewing method for fixed-route bus position information based on the multimodal route search result and an exemplary purchase-use method for a fixed-route bus ticket. Specifically, FIG. 13A is a diagram showing an exemplary application screen (an application screen 1300) for displaying a detailed content of one route candidate that is of a plurality of route candidates in the multimodal route search result and that uses the fixed-route bus. FIG. 13B is a diagram showing exemplary fixed-route bus ticket information (a fixed-route bus six-hour free ticket image information 1310) that is displayed on the display device 16 of the portable terminal 10.

As shown in FIG. 13A, the application screen 1300 includes a route candidate detail display region 1301, similarly to the application screen 810 in FIG. 8B.

On the route candidate detail display region 1301, there is displayed a detailed content of the route candidate that includes a fixed-route bus use portion, and on the fixed-route bus use portion, there are disposed a fixed-route bus position information viewing button 1302 and a fixed-route bus ticket purchase button 1303.

The user performs a handling of designating and deciding the fixed-route bus position information viewing button 1302, and thereby, the user causes the display content of the display device 16 of the portable terminal 10 to transition from the application screen 1300 to an application screen (fixed-route bus position information screen) for displaying the fixed-route bus position information about a bus that is used in the route candidate.

On the fixed-route bus position information screen, for example, there is displayed a map image of a range containing the fixed route of a fixed-route bus that is used in the route candidate displayed on the application screen 1300. On the map image, the fixed route corresponding to the route, a riding bus stop of the fixed-route bus on the route candidate, and the current position information and scheduled position information about the fixed-route bus may be superimposed and displayed. Further, on the map image, information (for example, character information such as “The fixed-route bus is operating on schedule” and “The fixed-route bus is running xx minutes behind schedule”) relevant to the delay situation of the fixed-route bus may be superimposed and displayed in association with the current position information about the fixed-route bus. Thereby, the user, for example, does not need to start a browser or the like in the portable terminal 10, to access the fixed-route bus position information, and the user can view the fixed-route bus position information, by a handling on the application screen 1300 relevant to the display of the route candidate using the fixed-route bus in the multimodal route search result. The user checks the current position information and scheduled position information about the fixed-route bus, the information relevant to the delay situation, and the like. Thereby, the user can know, for example, whether the fixed-route bus will arrive by a departure hour presented in the route candidate or will be delayed, and can use the information for determination of the selection of the route candidate, and the like.

The user performs a handling of designating and deciding the fixed-route bus ticket purchase button 1303, and thereby, can cause the display content of the display device 16 of the portable terminal 10 to transition from the application screen 1300 to an application screen (fixed-route bus ticket purchase screen) for purchasing a predetermined ticket for the fixed-route bus, specifically, a six-hour free ticket for the fixed-route bus. For example, the six-hour free ticket for the fixed-route bus is a specific time-limited ticket allowing a free alighting from the fixed-route bus for six hours in a predetermined geographic range (for example, in a particular city, town or village). Thereby, the user can send the bus ticket purchase request from the portable terminal 10 to the center server 20 and can purchase the six-hour free ticket, by performing a predetermined handling on the fixed-route bus ticket purchase screen through the input device 17 of the portable terminal 10. Then, the user causes the display device 16 of the portable terminal 10 to display the fixed-route bus ticket information (the fixed-route bus six-hour free ticket image information 1310) corresponding to the six-hour free ticket that is delivered from the center server 20 to the portable terminal 10 and is stored in the fixed-route bus ticket information storage unit 105 in response to a predetermined handling on a predetermined application screen for the route search application, and for example, causes the crew member of the fixed-route bus to view the fixed-route bus six-hour free ticket image information 1310, so that the user can use the fixed-route bus.

As shown in FIG. 13B, expiring hour information 1311, remaining time information 1312 and current hour information 1313 are superimposed and displayed on the fixed-route bus six-hour free ticket image information 1310 that is displayed on the display device 16.

The expiring hour information 1311 indicates the expiration hour of the six-hour free ticket for the fixed-route bus as the specific time-limited ticket.

The remaining time information 1312 indicates the remaining time before the expiring hour (expiration) of the six-hour free ticket. The remaining time information 1312 is dynamically displayed in a countdown manner, and after the expiration, information indicating the expiration is instead displayed. Thereby, on the application screen that is displayed on the display device 16 of the portable terminal 10, the remaining time before the expiration is dynamically displayed, in addition to the fixed-route bus ticket information. Therefore, it is possible to avoid an unfair use of the fixed-route bus ticket information corresponding to the specific time-limited ticket using a capture image of the application screen, for example.

The current hour information 1313 indicates the current hour, and is dynamically displayed in a count-up manner. Thereby, on the application screen that is displayed on the display device 16 of the portable terminal 10, the current hour is dynamically displayed, in addition to the fixed-route bus ticket information. Therefore, it is possible to avoid an unfair use of the fixed-route bus ticket information corresponding to the specific time-limited ticket using a capture image of the application screen, for example.

Thus, the user can purchase and use a predetermined ticket (for example, the six-hour free ticket) for the fixed-route bus, on the portable terminal 10, without exiting from the route search application. Accordingly, it is possible to enhance the convenience for the user.

The portable terminal 10 may perform a process relevant to the purchase of a predetermined ticket for the fixed-ticket bus or a process of displaying the fixed-route bus ticket information on the display device 16, in response to a user handling on a screen other than the application screen for the route search application. For example, the portable terminal 10 starts an application (referred to as a “fixed-route bus application”, hereinafter) that is provided from the fixed-route bus related server 30, and sends the bus ticket purchase request to the fixed-route bus related server 30, in response to a predetermined handling on a predetermined application screen for the fixed-route bus application. Then, in response to a predetermined handling on a predetermined application screen for the fixed-route bus application, the portable terminal 10 may cause the display device 16 to display the fixed-route bus ticket information that is delivered from the fixed-route bus related server 30. Further, for example, in response to a predetermined user handling on a fixed-route bus-relevant homepage (referred to as a “fixed-route bus page”, hereinafter) that is accessed through a browser and that is administered by the fixed-route bus related server 30 or the like, the portable terminal 10 performs a process relevant to the purchase of a predetermined ticket for the fixed-route bus, on the fixed-route bus page. Then, in response to a predetermined handling on the fixed-route bus page that is accessed through a browser, the portable terminal 10 may display, on the browser, the fixed-route bus ticket information that is sent as a web resource from the fixed-route bus related server 30. In this case, the user can access the fixed-route bus page through a browser that is installed in the portable terminal 10, and can purchase a predetermined ticket for the fixed-route bus through the browser of the portable terminal 10, or can display the fixed-route bus ticket information corresponding to the purchased ticket, on the browser, under the control from the fixed-route bus related server 30. Further, also for a predetermined transportation (for example, a public transportation such as the train, the expressway bus, the boat and the airplane) for which the operation plan including the operation route and the operation hour is previously specified, the portable terminal 10 may realize the purchase and use of a ticket by the user, by the same method as the method for the fixed-route bus.

Fixed-Route Bus Ticket Information Display Process

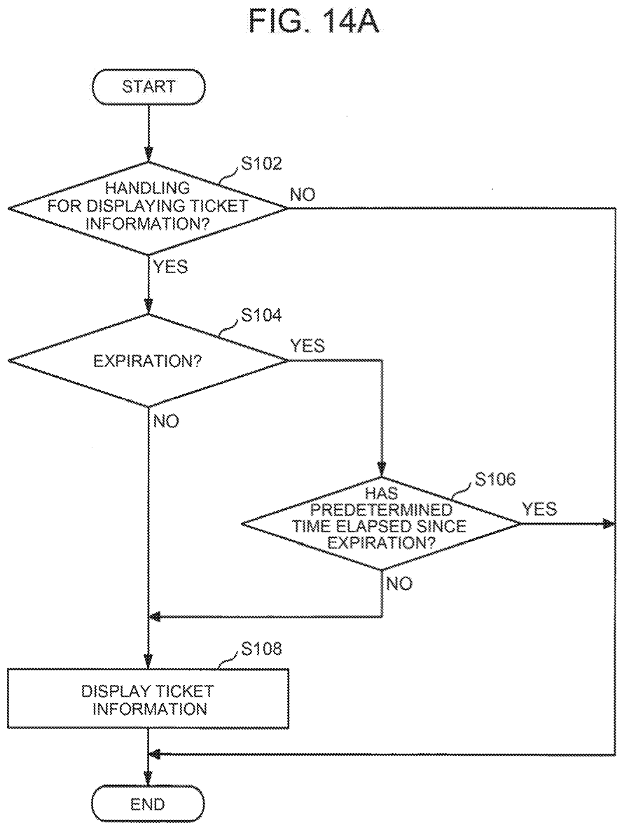

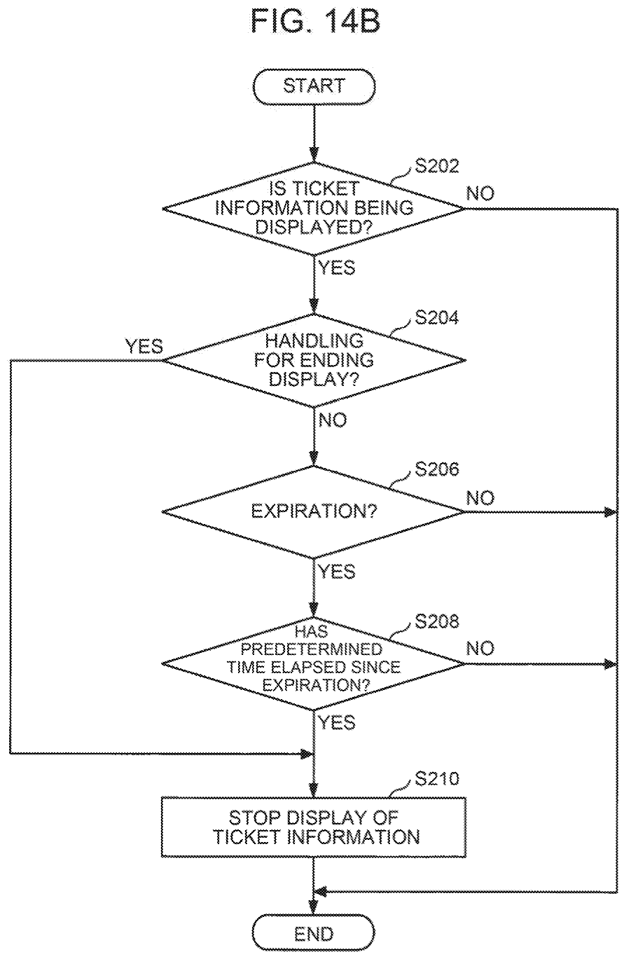

Next, a process (referred to as a “fixed-route bus ticket information display process”, hereinafter) relevant to the display of the fixed-route bus ticket information corresponding to the specific time-limited ticket on the display device 16 of the portable terminal 10 will be described with reference to FIG. 14A and FIG. 14B. The fixed-route bus ticket information display process is performed by the portable terminal 10 (the fixed-route bus ticket use assist processing unit 104).

FIG. 14A and FIG. 14B are flowcharts schematically showing exemplary fixed-route bus ticket information display processes by the portable terminal 10 (the fixed-route bus ticket use assist processing unit 104). For example, the flowchart in FIG. 14A is executed with a predetermined control period, in a state where the route search application of the portable terminal 10 is started and where the specific time-limited ticket information (for example, the fixed-route bus six-hour free ticket image information 1310 in FIG. 13B) about the fixed-route bus is not displayed. For example, the flowchart in FIG. 14B is executed with a predetermined control period, in a state where the route search application of the portable terminal 10 is started and where the specific time-limited ticket information about the fixed-route bus is displayed.

As shown in FIG. 14A, first, in step S102, the fixed-route bus ticket use assist processing unit 104 determines whether the user has performed a handling for displaying the fixed-route bus ticket information corresponding to the specific time-limited ticket for the fixed-route bus through the input device 17. In the case where the user has performed the handling, the fixed-route bus ticket use assist processing unit 104 proceeds to step S104, and in the case where the user has not performed the handling, the fixed-route bus ticket use assist processing unit 104 ends this process.

In step S104, the fixed-route bus ticket use assist processing unit 104 determines whether the specific time-limited ticket for the fixed-route bus has expired. In the case where the specific time-limited ticket for the fixed-route bus has expired, the fixed-route bus ticket use assist processing unit 104 proceeds to step S106, and in the case where the specific time-limited ticket for the fixed-route bus has not expired, the fixed-route bus ticket use assist processing unit 104 proceeds to step S108.

In step S106, the fixed-route bus ticket use assist processing unit 104 determines whether a predetermined time T1 has elapsed since the expiration of the specific time-limited ticket for the fixed-route bus. In the case where the predetermined time T1 has not elapsed since the expiration of the specific time-limited ticket for the fixed-route bus, the fixed-route bus ticket use assist processing unit 104 proceeds to step S108, and in the case where the predetermined time T1 has elapsed, the fixed-route bus ticket use assist processing unit 104 ends this process.

In step S108, the fixed-route bus ticket use assist processing unit 104 causes the display device 16 to display the fixed-route bus ticket information corresponding to the specific time-limited ticket, and ends this process.

Next, as shown in FIG. 14B, in step S202, the fixed-route bus ticket use assist processing unit 104 determines whether the fixed-route bus ticket information corresponding to the specific time-limited ticket is being displayed on the display device 16. In the case where the fixed-route bus ticket information corresponding to the specific time-limited ticket is being displayed on the display device 16, the fixed-route bus ticket use assist processing unit 104 proceeds to step S204, and in the case where the fixed-route bus ticket information corresponding to the specific time-limited ticket is not being displayed, the fixed-route bus ticket use assist processing unit 104 ends this process.

In step S204, the fixed-route bus ticket use assist processing unit 104 determines whether the user has performed a handling for ending the display of the fixed-route bus ticket information through the input device 17. In the case where the user has not performed the handling, the fixed-route bus ticket use assist processing unit 104 proceeds to step S206, and in the case where the user has performed the handling, the fixed-route bus ticket use assist processing unit 104 proceeds to step S210.

In step S206, the fixed-route bus ticket use assist processing unit 104 determines whether the specific time-limited ticket for the fixed-route bus has expired. In the case where the specific time-limited ticket for the fixed-route bus has expired, the fixed-route bus ticket use assist processing unit 104 proceeds to step S208, and in the case where the specific time-limited ticket for the fixed-route bus has not expired, the fixed-route bus ticket use assist processing unit 104 ends this process.

In step 5208, the fixed-route bus ticket use assist processing unit 104 determines whether the predetermined time T1 has elapsed since the expiration of the specific time-limited ticket for the fixed-route bus. In the case where the predetermined time T1 has elapsed since the expiration of the specific time-limited ticket for the fixed-route bus, the fixed-route bus ticket use assist processing unit 104 proceeds to step 5210, and in the case where the predetermined time T1 has not elapsed, the fixed-route bus ticket use assist processing unit 104 ends this process.

In step 5210, the fixed-route bus ticket use assist processing unit 104 stops (ends) the display of the fixed-route bus ticket information corresponding to the specific time-limited ticket for the fixed-route bus on the display device 16, and ends this process.

Thus, in this example, the fixed-route bus ticket use assist processing unit 104 permits the display device 16 to display the fixed-route bus ticket information corresponding to the specific time-limited ticket after the expiration of the specific time-limited ticket and before the elapse of the predetermined time T1, and prohibits the display device 16 from displaying the fixed-route bus ticket information after the elapse of the predetermined time T1.

Specifically, in the case where the predetermined time T1 has not elapsed since the expiration of the specific time-limited ticket, the fixed-route bus ticket use assist processing unit 104 causes the display device 16 to display the fixed-route bus ticket information corresponding to the specific time-limited ticket, in response to the predetermined user handling, and continues the display of the fixed-route bus ticket information displayed on the display device 16. On the other hand, in the case where the predetermined time T1 has elapsed since the expiration of the specific time-limited ticket, the fixed-route bus ticket use assist processing unit 104 causes the display device 16 not to display the fixed-route bus ticket information, even when the user has performed the predetermined handling, and stops the display of the fixed-route bus ticket information displayed on the display device 16.

Thereby, the portable terminal 10 can give a grace period before the display device 16 is prohibited from displaying the fixed-route bus ticket information after the expiration of the specific time-limited ticket, on the premise that the corresponding fixed-route bus ticket information cannot be displayed after the expiration of the specific time-limited ticket. Therefore, even when the specific time-limited ticket expires, for example, because of delay of arrival at a destination bus stop of the fixed-route bus, the user can give proof that the user is a purchaser of the specific time-limited ticket, and for example, can negotiate an alighting with no additional fare due to the delay or the like, with the crew member or the like. Accordingly, the portable terminal 10 makes it possible to avoid the unfair use of the specific time-limited ticket issued to the portable terminal 10 of the user, and to enhance the convenience for the user at the time of the use of the time-limited ticket.

The predetermined time T1 may be a constant time that is previously specified, and for example, may be 30 minutes.

The predetermined time T1 may vary, for example, depending on an actual operation situation, an estimated operation situation or the like of the fixed-route bus in which the user is currently riding. Specifically, in the case where the user is riding in a certain bus of the fixed-route bus at the timing of the expiration of the specific time-limited ticket, the predetermined time T1 may be set to a longer time as an actual delay time or predicted delay time of the certain bus with respect to the operation plan is longer.

Thereby, after the expiration of the specific ticket, the portable terminal 10 can give the grace period before the display device 16 is prohibited from displaying the ticket information, such that the grace period corresponds to an actual delay situation or a predicted delay situation of a transport machine (a certain bus of the fixed-route bus) in which the user is currently riding. Accordingly, the portable terminal 10 more appropriately allows both the avoidance of the unfair use of the time-limited ticket and the enhancement of the convenience for the user at the time of the use of the time-limited ticket.

On this occasion, the portable terminal 10 can acquire the information relevant to the delay situation of the fixed-route bus, the fixed-route bus position information, and the like, by accessing the fixed-route bus related server 30 directly or through the center server 20. Then, the portable terminal 10 compares the positioning history information of the GNSS device mounted on the portable terminal 10 and the current position information about the fixed-route bus. Thereby, the portable terminal 10 can identify a bus of the fixed-route bus in which the user is currently riding, and can know the delay situation of the bus. Further, the portable terminal 10 may identify the fixed-route bus in which the user is riding, based on one route candidate that is selected by the user from a plurality of route candidates in the multimodal route search (for example, based on a route candidate for which the route guide has been executed, or a route candidate for which the detailed content is repeatedly displayed by the user). Further, the portable terminal 10 may identify a bus of the fixed-route bus in which the user is riding, as a result that a pairing for a predetermined short-range communication (for example, WiFi® or Bluetooth®) or the like is performed between communication devices mounted on both of the portable terminal 10 and the fixed-route bus and pairing information is sent to the portable terminal 10 through the fixed-route bus related server 30. Further, the portable terminal 10 may predict the delay time, based on history information relevant to the past operation situation of the corresponding bus of the fixed-route bus. The history information can be acquired from the fixed-route bus related server 30.

As described above, in the case where the specific time-limited ticket has not expired, the fixed-route bus ticket use assist processing unit 104 may cause the display device 16 to display the remaining time before the expiration of the specific time-limited ticket in a countdown manner, together with the corresponding fixed-route bus ticket information, and in the case where the specific time-limited ticket has expired, instead of the remaining time in a countdown manner, the fixed-route bus ticket use assist processing unit 104 may cause the display device 16 to display information indicating the expiration of the specific time-limited ticket, together with the corresponding fixed-route bus ticket information.

Thereby, on the screen of the portable terminal 10, the remaining time before the expiration is dynamically displayed in addition to the fixed-route bus ticket information. Therefore, a predetermined person such as a crew member of the fixed-route bus can easily know whether the fixed-route bus ticket information is the fixed-route bus ticket information corresponding to the expired time-limited ticket. Accordingly, it is possible to avoid, for example, an unfairness in which the user alights from the fixed-route bus or the like by showing the crew member or the like the screen of the portable terminal 10 on which the ticket information about the expired ticket is displayed, despite no delay of the fixed-route bus.

In the case where a similar specific time-limited ticket is issued (delivered) to the portable terminal 10 for a predetermined transportation (for example, a public transportation such as the train, the expressway bus, the boat and the airplane) that is other than the fixed-route bus and for which the operation place including the operation route and the operation hour is previously specified, a process relevant to the display of the ticket information corresponding to the specific time-limited ticket may be performed in the same way as the case of the fixed-route bus. Thereby, even in the case of the predetermined transportation other than the fixed-route bus, the same effect as the case of the fixed-route bus is obtained. For example, the display content of the fixed-route bus ticket information on the application screen for the fixed-route bus application in the portable terminal 10 or on the fixed-route bus page of the browser can be controlled by the center server 20. Therefore, in this case, the fixed-route bus ticket information display process may be executed by the center server 20 (an example of the information processing device).

Generation Method for Macro Data

Next, a generation method for macro data based on the history data of the multimodal route search result will be described with reference to FIG. 15A, FIG. 15B, and FIG. 16A to FIG. 16D.

First, FIG. 15A and FIG. 15B are diagrams showing exemplary history data of the multimodal route search result that is accumulated in the route search result history storage unit 207, that is, an exemplary record group of the past multimodal route search result.

As shown in FIG. 15A and FIG. 15B, each record of the multimodal route search result is configured by data such as the user ID corresponding to the route search request, the departure place, the stop-off place, the destination place, information of whether the route search request is a route search request via the event information or spot information based on the event-spot retrieval (“VIA EVENT SPOT INFORMATION” in FIG. 15A), information relevant to the output (proposed) route candidates, information relevant to a selected route candidate (referred to as a “selected route”, hereinafter), and information relevant to presence of use-prior check.

The information relevant to the output route candidates indicates whether the route candidates output as the multimodal route search result include a route candidate using each object movement means.

Further, the information relevant to the output route candidates includes information (“HIGH CONVENIENCE” in FIG. 15A) indicating whether there is a route candidate that uses the object movement means with a relatively high convenience, and information (“WITHOUT CONDITION OF CONVENIENCE” in FIG. 15A) indicating whether there is a route candidate that uses the object movement means regardless of the condition relevant to the convenience.

Examples of the condition for determining whether the convenience is relatively high include a condition that the wait time for transfer is relatively short (specifically, the wait time for transfer is shorter than a predetermined threshold), a condition that the use time for walking is relatively short (specifically, the use time for walking is shorter than a predetermined threshold), and a condition that the required fee is relatively low (specifically, the required fee is lower than a predetermined threshold).

The information relevant to the selected route indicates whether one route candidate selected by the user from the route candidates uses the object movement means.

The route candidate selected by the user from the plurality of route candidates in the multimodal route search result may be, for example, a route candidate for which the above-described route guide is executed, or a route candidate that is of the plurality of route candidates in the multimodal route search result and for which the number of displays of the detailed information or the time of the display of the detailed information is equal to or more than a predetermined threshold.

The information relevant to the use-prior check indicates a history of use of various assist services (for example, the viewing of the above-described fixed-route bus position information, the purchase of a predetermined ticket for the fixed-route bus, the booking of the taxi, the assist for the use of the cycle sharing, and the viewing of the parking place information) based on the multimodal route search result.

The macro data generation unit 206 generates the macro data based on the record group in the route search result history storage unit 207.

Next, FIG. 16A to FIG. 16D are diagrams for describing the macro data. Specifically, FIG. 16A and FIG. 16B are diagrams for conceptually describing the macro data, and FIG. 16C and FIG. 16D are diagrams showing exemplary macro data.

Specifically, a bar graph with respect to the object movement means that corresponds to “(1) ROUTE SEARCH ‘HOW CAN I GOT” in FIG. 16A and FIG. 16B schematically shows the total number (referred to as a “total route search request number”, hereinafter) of route search requests satisfying a certain condition. Further, a bar graph with respect to the object movement means that corresponds to “(2) ROUTE SEARCH ‘YOU CAN GO IN THIS WAY” in FIG. 16A and FIG. 16B schematically shows the number (referred to as a “route candidate use number”, hereinafter) of uses of the object movement means as the route candidate in the multimodal route search result in the total route search request number. Further, a bar graph with respect to the object movement means that corresponds to “(3) DETAIL DISPLAY ‘I WILL GO IN THIS WAY” in FIG. 16A and FIG. 16B schematically shows the number (referred to as a “selected route use number”, hereinafter) of uses of the object movement means as the selected route in the total route search request number. Further, a bar graph with respect to the object movement means that corresponds to “(4) GUIDE START” in FIG. 16A and FIG. 16B schematically shows the number (referred to as a “route guide number”, hereinafter) of route guides for the selected route including the use of the object movement means in the total route search request number. Further, a bar graph with respect to the object movement means that corresponds to “(5) BOOKING, PRIOR CHECK OR THE LIKE” in FIG. 16A and FIG. 16B shows the number (referred to as a “booking-prior check use number”, hereinafter) of uses of various assist services (for example, the viewing of the above-described fixed-route bus position information, the purchase of a predetermined ticket for the fixed-route bus, the booking of the taxi, the assist for the use of the cycle sharing, and the viewing of the parking place information) based on the multimodal route search result in the total route search request number. Further, a bar graph with respect to the object movement means that corresponds to “(6) USE (SETTLEMENT) ‘I COULD MOVE” in FIG. 16A and FIG. 16B shows the number (referred to as a “movement number”, hereinafter) of actual movements using the object movement means in the total route search request number. Further, a bar graph with respect to the object movement means that corresponds to “(7) MULTIPLE USES ‘I WILL USE THIS WAY AGAIN” in FIG. 16A and FIG. 16B shows the number (referred to as a “multiple movement user number”) of users that moves multiple times using the object movement means in the total route search request number.

Dotted-line bar graphs of the bar graphs in FIG. 16A and FIG. 16B, for calculation, require data acquisition from the exterior of the multimodal route providing system 1.

For example, as shown in FIG. 16A, the ratio of uses of the object movement means in the presented route candidates to the route search request group (that is, the rate of the route candidate use number of the object movement means to the total route search request number) can be regarded as the degree (“SUPPLY RATE” of the object movement means in FIG. 16A) of contribution potential of the object movement means to user's movement needs. Accordingly, for example, the macro data generation unit 206 may calculate the supply rate of the object movement means for each of combinations of a plurality of departure areas and a plurality of destination areas, and may generate the macro data including the calculation result (see FIG. 16C). Thereby, the administrator or operator (referred to as the “administrator or the like”, hereinafter) of the center server 20 can know the supply rate of each object movement means, for each combination of the departure areas and the destination areas. For example, an area (referred to as an “analysis object area”, hereinafter) as an analysis object, which is contained in the search object area, is comparted in a grid pattern with a predetermined distance (for example, 500 meters), and the comparted grid areas (referred to as “compartment areas”, hereinafter) are set as departure areas and destination areas. Thereby, combinations of the departure areas and the destination areas may be specified.

Similarly, the ratio of uses of object movement means in the selected route to the route search request group (that is, the rate of the selected route use number of the object movement means to the total route search request number) can be regarded as the degree (“DEMAND RATE” of the object movement means in FIG. 16A) of demand for the object movement means to user's movement needs. Accordingly, the macro data generation unit 206 may calculate the demand rate of the object movement means for each of combinations of a plurality of departure areas and a plurality of destination areas, and may generate the macro data including the calculation result (see FIG. 16D). Thereby, the administrator or the like of the center server 20 can know the demand rate of each object movement means, for each combination of the departure areas and the destination areas.

Further, the ratio of uses of the viewing service for the fixed-route bus position information to route search requests of the route search request group for which the user has selected route candidates including the fixed-route bus (that is, the rate of the booking-prior check use number of the viewing service for the fixed-route bus position information to the selected route use number of the fixed-route bus) can be regarded as the use rate of the viewing service for the fixed-route bus position information. Accordingly, the macro data generation unit 206 may calculate the ratio of uses of the viewing service for the fixed-route bus position information to route search requests of the route search request group for which the user has selected route candidates including the fixed-route bus, and may generate the macro data including the calculation result. Thereby, the administrator or the like of the center server 20 can know the use rate of the viewing service for the fixed-route bus position information.

Further, the ratio of uses of the purchase service for the fixed-route bus ticket to route search requests of the route search request group for which the user has selected route candidates including the fixed-route bus (that is, the rate of the booking-prior check use number of the purchase service for the fixed-route bus ticket to the selected route use number of the fixed-route bus) or the actual number of uses of the purchase service for the fixed-route bus ticket can be regarded as the use rate or sales of the fixed-route bus ticket via the route search application. Accordingly, the macro data generation 206 may calculate the ratio of uses of the purchase service for the fixed-route bus ticket to route search requests of the route search request group for which the user has selected route candidates including the fixed-route bus or the actual number of uses of the purchase service for the fixed-route bus ticket, and may generate the macro data including the calculation result. Thereby, the administrator or the like of the center server 20 can know the use rate or sales of the fixed-route bus ticket via the route search application.

Further, the ratio of uses of the booking service for the taxi to route search requests of the route search request group for which the user has selected route candidates including the taxi (that is, the rate of the booking-prior check use number of the booking service for the taxi to the selected route use number of the taxi) can be regarded as a customer getting rate at which the booking service for the taxi leads the user to use the taxi. Accordingly, the macro data generation unit 206 may calculate the ratio of uses of the booking service for the taxi to route search requests for which the user has selected route candidates including the taxi, and may generate the macro data including the calculation result. Thereby, the administrator or the like of the center server 20 can know the customer getting rate at which the booking service for the taxi leads the user to book the taxi.

Further, the ratio of uses of the use assist service for the cycle sharing to route search requests of the route search request group for which the user has selected route candidates including the use of the cycle sharing (that is, the rate of the booking-prior check use number of the use assist service for the cycle sharing to the selected route use number of the cycle sharing) can be regarded as a customer getting rate at which the use assist service for the cycle sharing leads the user to use the cycle sharing. Accordingly, the macro data generation unit 206 may calculate the ratio of uses of the use assist service for the cycle sharing to route search requests of the route search request group for which the user has selected route candidates including the use of the cycle sharing, and may generate the macro data including the calculation result. Thereby, the administrator or the like of the center server 20 can know the customer getting rate at which the user is led to use the cycle sharing, based on the macro data.

Further, the ratio of uses of the viewing service for the parking place information to route search requests of the route search request group for which the user has selected route candidates including the use of the automobile (that is, the rate of the booking-prior check use number of the viewing service for the parking place information to the selected route use number of the automobile) can be regarded as a customer getting rate at which the viewing service for the parking place information leads the user to use the parking place. Accordingly, the macro data generation unit 206 may calculate the ratio of uses of the viewing service for the parking place information to route search requests of the route search request group for which the user has selected route candidates including the use of the automobile, and may generate the macro data including the calculation result. Thereby, the administrator or the like of the center server 20 can know the customer getting rate at which the viewing service for the parking place information leads the user to use the parking place.

Further, for example, as shown in FIG. 16B, by performing attribute classification of the user having selected a route candidate including certain object movement means (the fixed-route bus in the FIG. 16B), it is possible to know what kind of attribute into which the user having selected the route candidate including the certain object movement means is classified.

Specifically, the macro data generation unit 206 may calculate the ratio in terms of sex and age, the ratio in terms of resident area such as information of whether the user lives in Japan or overseas and information of whether the user lives in a predetermined city or outside the city, the ratio in terms of whether the user possess an automobile, the ratio in terms of whether the user possess a commutation ticket, and the like, and may generate the macro data including the calculation result. On this occasion, similarly to the supply rate and demand rate of the object movement means, the macro data generation unit 206 may calculate the ratios for each of combinations of a plurality of departure areas and a plurality of destination areas. Thereby, the administrator or the like of the center server 20 can know the attribute classification (attribute rate) of each object movement means, for each combination of the departure areas and the destination areas.

For example, the attribute information (for example, sex, age, residence, information of whether the user possess an automobile, information of whether the user possess a commutation ticket, and the like) about each of a plurality of users may be contained in the auxiliary storage device 22, an external storage device that is communicably connected with the center server 20, or the like, in association with the user identification information (for example, the user ID). Thereby, the macro data generation unit 206 can refer to the attribute information about each user, and can generate the above-described macro data.

Thus, based on the history data of the multimodal route search result, for each of a plurality of combinations of departure areas and destination areas, the macro data generation unit 206 calculates, for each of a plurality of object movement means, at least one of a first ratio (that is, the supply rate) of use in the route candidate proposed in the route search result and a second ratio (that is, the demand rate) of use in the route candidate (that is, the selected route) selected from the route search result by the user, with respect to the route search request group corresponding to the combination of the departure area and the destination area. Then, for each of the combinations of the departure areas and the destination areas, the macro data generation unit 206 generates the macro data associated with the departure area, the destination area, and at least one of the first ratio (supply rate) and the second ratio (demand rate) for each of the plurality of object movement means.

Thereby, for a plurality of user's movement needs from the departure area to the destination area, the center server 20 can generate the macro data corresponding to the degree of the support of the movement needs by the object movement means. Further, for a plurality of user's movement needs from the departure area to the destination area, the center server 20 can generate the macro data corresponding to user's tendency of the selection of what kind of movement means. Accordingly, the center server 20 can generate the output data (macro data) for knowing a variety of tendency and the like relevant to the movement of the user from macroperspective, based on the history data of multimodal route search results corresponding to a plurality of user's requests.

Further, for each of the combinations of the departure areas and the destination areas, the macro data generation unit 206 may generate the macro data associated with the departure area, the destination area, the information relevant to the attribute of the user having selected the route candidate including the use of the object movement means from route search results to the route search request group corresponding to the combination of the departure area and the destination area, for each of a plurality of object movement means.

Thereby, for a plurality of movement needs from the departure area to the destination area, the center server 20 can generate the macro data corresponding to what kind of object movement means selected by the user having what kind of attribute.

Further, the information relevant to the attribute of the user may include information relevant to at least one of the ratio in terms of the sex and age of the user having selected the route candidate including the use of the object movement means from route search results to the route search request group corresponding to the combination of the departure area and the destination area, the ratio in terms of the resident area of the user, the ratio in terms of whether the user possess an automobile, and the ratio in terms of whether the user possesses a commutation ticket of the object movement means between the departure area and the destination area.

Thereby, for a plurality of movement needs from the departure area to the destination area, the center server 20 can generate data corresponding to what kind of movement means selected by the user having what kind of attribute, in terms of the specific classified user attribute.

What is claimed is:

1. An information providing device comprising:
a route search unit configured to search a route from a departure place to a destination place, the route using one or more of a plurality of movement means; and
a display control unit configured to cause a display unit of a user terminal to display a route search result by the route search unit, in accordance with a display specification, the route search result including one or a plurality of route candidates, wherein
a first display specification includes at least one of information of whether to display a particular route candidate and a display order of the particular route candidate in the plurality of route candidates, the first display specification being a display specification that is relevant to the particular route candidate,
the first display specification is determined based on a unique condition that is specified for particular movement means, and
the particular route candidate is a route candidate that uses the particular movement means, the particular movement means being included in the plurality of movement means.

2. The information providing device according to claim 1, wherein:
a second display specification includes the display order, the second display specification being a display specification that is relevant to a route candidate other than the particular route candidate of the plurality of route candidates; and
the second display specification is determined based on a common condition that is specified for the plurality of route candidates.

3. The information providing device according to claim 2, wherein:
the first display specification includes the information of whether to display the particular route candidate and the display order of the particular route candidate;
the first display specification is determined based on the common condition and the unique condition; and
the unique condition is applied in preference to the common condition.

4. The information providing device according to claim 1, wherein:
the particular movement means includes at least one of a taxi and a ride sharing; and
the display control unit is configured to
cause the display unit to display the particular route candidate, when a use distance of the particular movement means in the particular route candidate is shorter than a first threshold, and
cause the display unit not to display the particular route candidate, when the use distance is equal to or longer than the first threshold.

5. The information providing device according to claim 2, wherein:
the particular movement means includes at least one of a taxi and a ride sharing; and
the display control unit is configured to
cause the display unit to display the particular route candidate, when a use distance of the particular movement means in the particular route candidate is shorter than a first threshold, and
cause the display unit not to display the particular route candidate, when the use distance is equal to or longer than the first threshold.

6. The information providing device according to claim 3, wherein:
the particular movement means includes at least one of a taxi and a ride sharing; and
the display control unit is configured to
cause the display unit to display the particular route candidate, when a use distance of the particular movement means in the particular route candidate is shorter than a first threshold, and
cause the display unit not to display the particular route candidate, when the use distance is equal to or longer than the first threshold.

7. The information providing device according to claim 1, wherein:
the particular movement means includes walking; and
the display control unit is configured to
cause the display unit to display the particular route candidate, when a used distance of the walking in the particular route candidate is shorter than a second threshold, and
cause the display unit not to display the particular route candidate, when the use distance of the walking is equal to or longer than the second threshold.

8. The information providing device according to claim 2, wherein:
the particular movement means includes walking; and
the display control unit is configured to
cause the display unit to display the particular route candidate, when a used distance of the walking in the particular route candidate is shorter than a second threshold, and
cause the display unit not to display the particular route candidate, when the use distance of the walking is equal to or longer than the second threshold.

9. The information providing device according to claim 3, wherein:
the particular movement means includes walking; and
the display control unit is configured to
cause the display unit to display the particular route candidate, when a used distance of the walking in the particular route candidate is shorter than a second threshold, and
cause the display unit not to display the particular route candidate, when the use distance of the walking is equal to or longer than the second threshold.

10. The information providing device according to claim 1, wherein:
the particular movement means includes at least one of a private-use automobile and a private-use bicycle; and
the display control unit is configured to cause the display unit to display a first route candidate in a state where a position of the first route candidate is fixed to be later than route candidates other than the first route candidate, the first route candidate being a route candidate that is included in the plurality of route candidates and that uses only the automobile or the bicycle.

11. The information providing device according to claim 10, wherein:
the particular movement means includes at least one of a private-use automobile and a private-use bicycle; and
the display control unit is configured to cause the display unit to display a first route candidate in a state where a position of the first route candidate is fixed to be later than route candidates other than the first route candidate, the first route candidate being a route candidate that is included in the plurality of route candidates and that uses only the automobile or the bicycle.

12. An information providing system including a user terminal and an information processing device configured to communicate with the user terminal, the information providing system comprising:
a route search unit configured to search a route from a departure place to a destination place, the route using one or more of a plurality of movement means; and
a display control unit configured to cause a display unit of the user terminal to display a route search result by the route search unit, in accordance with a display specification, the route search result including one or a plurality of route candidates, wherein
a first display specification includes at least one of information of whether to display a particular route candidate and a display order of the particular route candidate in the plurality of route candidates, the first display specification being a display specification that is relevant to the particular route candidate,
the first display specification is determined based on a unique condition that is specified for particular movement means, and
the particular route candidate is a route candidate that uses the particular movement means, the particular movement means being included in the plurality of movement means.

13. The information providing system according to claim 12, wherein:
a second display specification includes the display order, the second display specification being a display specification that is relevant to a route candidate other than the particular route candidate of the plurality of route candidates; and
the second display specification is determined based on a common condition that is specified for the plurality of route candidates.

14. The information providing system according to claim 13, wherein:
the first display specification includes the information of whether to display the particular route candidate and the display order of the particular route candidate;
the first display specification is determined based on the common condition and the unique condition; and
the unique condition is applied in preference to the common condition.

15. An information providing method to be executed by an information providing device, the information providing method comprising:
searching a route from a departure place to a destination place, the route using one or more of a plurality of movement means; and
causing a display unit of a user terminal to display a route search result, in accordance with a display specification, the route search result including one or a plurality of route candidates, wherein
a first display specification includes at least one of information of whether to display a particular route candidate and a display order of the particular route candidate in the plurality of route candidates, the first display specification being a display specification that is relevant to the particular route candidate,
the first display specification is determined based on a unique condition that is specified for particular movement means, and
the particular route candidate is a route candidate that uses the particular movement means, the particular movement means being included in the plurality of movement means.

16. The information providing method according to claim 15, wherein:
a second display specification includes the display order, the second display specification being a display specification that is relevant to a route candidate other than the particular route candidate of the plurality of route candidates; and
the second display specification is determined based on a common condition that is specified for the plurality of route candidates.

17. The information providing method according to claim 16, wherein:
the first display specification includes the information of whether to display the particular route candidate and the display order of the particular route candidate;
the first display specification is determined based on the common condition and the unique condition; and
the unique condition is applied in preference to the common condition.

18. A non-transitory recording medium storing a program, wherein the program causes an information providing device to execute:
searching a route from a departure place to a destination place, the route using one or more of a plurality of movement means; and
causing a display unit of a user terminal to display a route search result, in accordance with a display specification, the route search result including one or a plurality of route candidates, wherein
a first display specification includes at least one of information of whether to display a particular route candidate and a display order of the particular route candidate in the plurality of route candidates, the first display specification being a display specification that is relevant to the particular route candidate,
the first display specification is determined based on a unique condition that is specified for particular movement means, and
the particular route candidate is a route candidate that uses the particular movement means, the particular movement means being included in the plurality of movement means.

19. The recording medium according to claim 18, wherein:
a second display specification includes the display order, the second display specification being a display specification that is relevant to a route candidate other than the particular route candidate of the plurality of route candidates; and
the second display specification is determined based on a common condition that is specified for the plurality of route candidates.

20. The recording medium according to claim 19, wherein:
the first display specification includes the information of whether to display the particular route candidate and the display order of the particular route candidate;
the first display specification is determined based on the common condition and the unique condition; and
the unique condition is applied in preference to the common condition.
